(19) United States
(12) Patent Application Publication
(10) Pub. No.: US 2026/0361960 A1
(43) Pub. Date: Nov. 12, 2026

(54) ELECTRONIC DEVICE AND OPERATION METHOD THEREOF

(71) Applicant: SAMSUNG ELECTRONICS CO., LTD., Suwon-si (KR)

(72) Inventors: Seungmin CHOI, Suwon-si (KR); Sehyun BAE, Suwon-si (KR); Saeeun CHOI, Suwon-si (KR)

(73) Assignee: SAMSUNG ELECTRONICS CO., LTD., Suwon-si (KR)

(21) Appl. No.: 19/718,853

(22) Filed: Jun. 24, 2026

Related U.S. Application Data
(63) Continuation of application No. PCT/KR2024/017301, filed on Nov. 5, 2024.

(30) Foreign Application Priority Data
Dec. 26, 2023 (KR) 10-2023-0191845

(51) Int. Cl. H04N 21/466

(52) U.S. Cl. CPC H04N 21/4666

(57) ABSTRACT

An electronic device and an operation method thereof. The operation method includes obtaining license information about a user for content according to metadata information about the content and a content viewing history associated with a content provider that is acquired on the basis of session information corresponding to content viewing; obtaining application subscription information and application preference information about the user by making an inference from the content viewing history associated with the content providers and the license information; and obtaining recommended content according to the application subscription information and the application preference information about the user.

### CROSS-REFERENCE TO RELATED APPLICATION(S)

This application is a continuation application, claiming priority under § 111(a), of International Application No. PCT/KR2024/017301, filed on Nov. 5, 2024, which is based on and claims the benefit of Korean patent application number 10-2023-0191845, filed on Dec. 26, 2023, in the Korean Intellectual Property Office, the disclosures of which are incorporated by reference herein in their entireties.

### TECHNICAL FIELD

Various embodiments relate to an electronic device and an operating method thereof. More particularly, the various embodiments relate to an electronic device for recommending content and an operating method thereof.

### BACKGROUND ART

Various content providers provide various types of content such as movies, dramas, TV shows, and games through applications of the respective content providers. However, as the number of content providers increases, there are many cases in which the same content is provided redundantly by different applications. In this case, a content integration service is used to allow users to select and view content in consideration of purchase methods and conditions for each application.

The content integration service provides convenience to a user's content search by recommending personalized content for each individual, and may improve the quality of content recommendation by re-utilizing usage history data of the user for the recommended content when recommending content.

However, in most cases, because information viewed by the user in an individual application is not shared with the content integration service, there is a limitation to the amount of usage history data of users that may be obtained by the content integration service. Therefore, there is a need for research on a method that may overcome such a limitation.

### DISCLOSURE OF INVENTION

### Solution to Problem

An operating method of an electronic device according to an embodiment may include obtaining session information on each content viewing of a user and metadata information on each content.

The operating method of the electronic device according to an embodiment may include obtaining license information of the user for the content according to a content viewing history associated with a content provider that is obtained based on the session information corresponding to content viewing and the metadata information for the content.

The operating method of the electronic device according to an embodiment may include obtaining application subscription information and application preference information of the user by making an inference from the content viewing history associated with the content provider and the license information.

The operating method of the electronic device according to an embodiment may include obtaining recommended content according to the application subscription information and the application preference information of the user.

An electronic device according to an embodiment may include memory storing one or more instructions.

The electronic device according to an embodiment may include one or more processors configured to execute the one or more instructions stored in the memory.

The one or more processors may be configured to execute the one or more instructions to obtain license information of a user for content according to a content viewing history for each content provider obtained based on session information corresponding to content viewing and metadata information for the content.

The one or more processors may be configured to execute the one or more instructions to obtain application subscription information and application preference information of the user according to the content viewing history for each content provider and the license information.

The one or more processors may be configured to execute the one or more instructions to obtain recommended content according to the application subscription information and the application preference information of the user.

A computer-readable recording medium according to an embodiment may be a computer-readable recording medium having recorded thereon a program for implementing an operating method of a projector for receiving a user input, the operating method including obtaining license information of a user for content according to a content viewing history associated with a content provider obtained based on session information corresponding to content viewing and metadata information for the content.

The computer-readable recording medium according to an embodiment may be the computer-readable recording medium having recorded thereon the program for implementing the operating method of the projector for receiving the user input, the operating method including obtaining application subscription information and application preference information of the user by making an inference from the content viewing history associated with the content provider and the license information.

The computer-readable recording medium according to an embodiment may be the computer-readable recording medium having recorded thereon the program for implementing the operating method of the projector for receiving the user input, the operating method including obtaining recommended content according to the application subscription information and the application preference information of the user.

### BRIEF DESCRIPTION OF DRAWINGS

FIG. 1A is a diagram illustrating an example in which an electronic device operates according to the related art.

FIG. 1B is a diagram illustrating an example in which an electronic device operates according to an embodiment of the present disclosure.

FIG. 2 is a block diagram illustrating a configuration of an electronic device according to an embodiment of the present disclosure.

FIG. 3 is a block diagram for describing in more detail a configuration of an electronic device according to another embodiment of the present disclosure.

FIG. 4 is a diagram illustrating an example of session information according to an embodiment of the present disclosure.

FIG. 5 is a diagram illustrating an example of a session information flow according to an embodiment of the present disclosure.

FIG. 6 is a flowchart illustrating an operating method of an electronic device according to an embodiment of the present disclosure.

FIG. 7 is a flowchart illustrating an example of recommending content when an electronic device is a server according to an embodiment of the present disclosure.

FIG. 8 is a flowchart illustrating an example of recommending content when an electronic device is an on-device type device according to an embodiment of the present disclosure.

FIG. 9 is a flowchart illustrating an operating method of an electronic device according to an embodiment of the present disclosure.

FIG. 10 is a diagram illustrating an example of a method by which an electronic device determines a weight for each item to be used for content recommendation by using artificial intelligence (AI) according to an embodiment of the present disclosure.

FIG. 11 is a diagram illustrating an example of a method by which an electronic device determines whether content is played by using information on an operation of a codec by using AI according to an embodiment of the present disclosure.

FIG. 12 is a diagram illustrating an example in which an electronic device performs scoring by applying a weight for each date to a number of times each content is viewed in a plurality of applications in order to determine application preference information according to an embodiment of the present disclosure.

FIG. 13 is a diagram illustrating an example in which an electronic device performs scoring by applying a weight for each date to a time during which each content is viewed in a plurality of applications in order to determine application preference information according to an embodiment of the present disclosure.

FIG. 14 is a diagram illustrating an example in which an electronic device performs scoring by applying a weight for each item to a score based on a number of times each content is viewed and a viewing time of each content in order to determine application preference information according to an embodiment of the present disclosure.

FIG. 15 is a flowchart illustrating an operating method of an electronic device according to an embodiment of the present disclosure.

### MODE FOR THE INVENTION

Hereinafter, embodiments of the disclosure will be described in detail with reference to the accompanying drawings so that the embodiments of the disclosure may be easily implemented by one of ordinary skill in the art. However, the present disclosure may be implemented in various different forms and is not limited to the embodiments described herein.

In the disclosure, general terms that have been widely used nowadays are selected in consideration of functions of the disclosure, but various other terms may be selected according to the intentions of technicians in the art, precedents, new technologies, etc. Accordingly, the terms used herein should be defined not based on the names thereof but based on the meanings thereof and the whole context of the disclosure.

In addition, the terms used in the present disclosure are used only to describe specific embodiments, and are not intended to limit the present disclosure.

Throughout the specification, when a component is referred to as being “connected” to another component, it will be understood to include that the component is “directly connected” to the other component or is “electrically connected” to the other component with another component therebetween.

In the specification and particularly in the claims, “the” and similar referents may be used to indicate both singular and plural forms. Operations for describing a method according to the disclosure may be performed in a suitable order unless the context clearly dictates otherwise. The disclosure is not limited to the order of the operations described.

The expressions “in some embodiments”, “in an embodiment” and the like appearing in various parts of the specification are not necessarily referring to the same embodiment of the disclosure.

Some embodiments of the disclosure may be represented by functional block configurations and various operations. Some or all of functional blocks may be implemented by various numbers of hardware and/or software configurations for performing certain functions. For example, the functional blocks of the present disclosure may be implemented by one or more microprocessors or may be implemented by circuit components for a certain function. In addition, for example, the functional blocks of the present disclosure may be implemented in various programming or scripting languages. The functional blocks may be implemented in an algorithm executed by one or more processors. In addition, the present disclosure may employ related-art techniques for electronic configuration, signal processing, and/or data processing, etc. The words “mechanism”, “element”, “means”, and “configuration” are used broadly and are not limited to mechanical or physical embodiments.

Also, connection lines or connection members between components illustrated in the drawings are merely illustrative of functional connections and/or physical or circuit connections. In an actual device, connections between components may be represented by various functional connections, physical connections, or circuit connections that are replaceable or added.

Also, the term “ . . . unit” or “ . . . module” refers to a unit that performs at least one function or operation, and the unit may be implemented in hardware or software or in a combination of hardware and software.

In addition, in the specification, the term “user” may refer to a person who controls a function or an operation of an electronic device by using the electronic device. In an embodiment, users using the same account on a content integration service may be determined as the same user.

Hereinafter, the present disclosure will be described in detail with reference to the accompanying drawings.

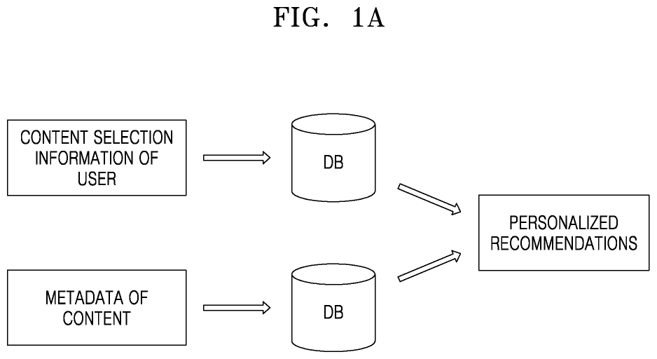

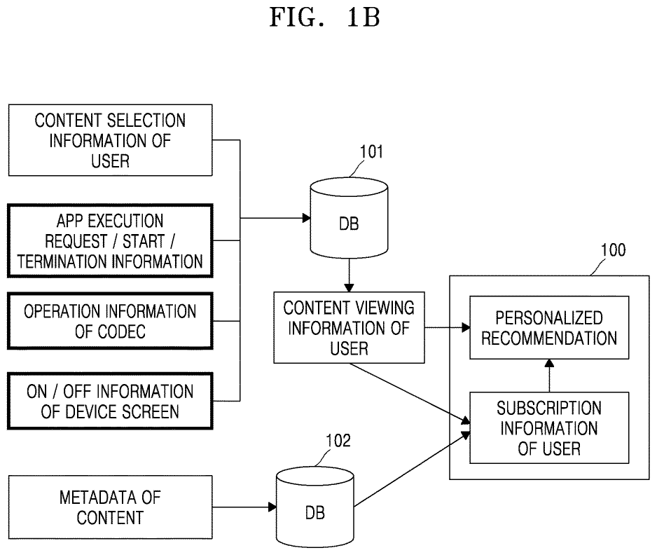

FIG. 1A is a diagram illustrating an example in which an electronic device operates according to the related art.

An electronic device provides a content integration service so that a user may easily search for desired content from a plurality of applications that provide content. In this case, the plurality of applications may include over the top (OTT) service applications operated or provided by content providers. Different applications provided by different content providers may provide the same content.

The content integration service may assist the user's content search by obtaining content selection information and content metadata information from a database storing the content selection information of the user and a database storing the content metadata information periodically provided by the content providers and recommending content to the user based on the obtained content selection information and content metadata information.

In the present disclosure, “content selection information” may refer to information related to an operation in which the user selects content. For example, the content selection information of the user may include information on a content provider previously selected by the user from among a plurality of pieces of recommended content, a date and time when the user selected the content, a name of the selected content, and the number of times the content is selected.

FIG. 1B is a diagram illustrating an example in which an electronic device operates according to an embodiment of the present disclosure.

The electronic device 100 according to an embodiment of the present disclosure may recommend content to a user by using at least one of device log information including not only content selection information of the user and metadata information but also execution request information for an application providing selected content, start and termination information of the application, operation information of a codec for executing the selected content, and on/off information of a content playback screen.

The execution request/start/termination information of the application may include at least one of the execution request information of the application, the start information of the application, and the termination information of the application. The execution request information of the application may refer to log information requesting execution of the application selected by the user. The start information of the application may refer to information indicating that the application is executed or started in response to an execution request of the application. The start information of the application may include a start time of the application, and a name and a type of the application. The termination information of the application may refer to information indicating that the executed or started application is terminated. The termination information of the application may include a termination time and a termination method of the application. The electronic device may determine whether the application has actually been executed, how long the execution has continued, and the like by referring to the execution request/start/termination information of the application.

The operation information of the codec may refer to information related to execution and termination of the codec. In the present disclosure, “codec” may be a collective term for a coder that converts an audio or video signal into a digital signal and a decoder that converts a digital signal into an audio or video signal. In an embodiment, the codec may refer to a program required to play or execute the selected content. In an embodiment, the operation information of the codec may include a type and a name of the executed codec, a time when the codec is executed, a time when the codec is terminated, a time during which the execution of the codec is maintained, and the like. The electronic device 100 may determine whether the content has actually been played by using the operation information of the codec.

The on/off information of the content playback screen may include information indicating that the content playback screen is turned on and operated and information indicating that the content playback screen is turned off and terminated. When power is applied to a content playback device and content is being played, the content playback screen may be turned on and operated. On the other hand, when the content playback device is turned off or a screen saver is executed, the content playback screen may be turned off. The electronic device 100 may determine whether a session is terminated by using the on/off information of the content playback screen. The content playback device may be the same device as the electronic device 100 or may be a separate device.

In the present disclosure, “session” may refer to an interval from a time point when a user input for selecting the content is obtained to a time point when viewing of the selected content is terminated. The session will be described below in detail.

The electronic device 100 according to an embodiment of the present disclosure may predict whether the content has actually been played after the user selects the content, how long the selected content has been played, and the like by additionally using information that has not been used in the related art, that is, the execution request information for the application of a content provider providing the selected content, the start and termination information of the application, the operation information of the codec for executing the selected content, the on/off information of the content playback screen, and the like.

The electronic device 100 according to an embodiment of the present disclosure may predict a content viewing history of the user for each content provider.

In the related art, an electronic device considers that all content selected by a user have been viewed by the user. However, there are cases where, although the user selects content, the user may not view the content because an application for viewing is not installed, or where the user terminates the content without viewing the content even if the user executes the application.

The electronic device 100 according to an embodiment of the present disclosure may determine that the content has not been viewed when there is no execution information of the application or when the codec does not operate even if the user selects the content.

The electronic device 100 according to an embodiment of the present disclosure may predict license information of the user for each content based on the predicted content viewing history for each content provider and the metadata information periodically provided by the content provider.

In the present disclosure, “license information of the user” may refer to an authority that the user has over the content. For example, the license information of the user may be one of subscription, purchase, rental, and free. That is, the user may be subscribing to the content, may have purchased the content, may have rented the content, or may be able to subscribe to the content for free.

According to an embodiment of the present disclosure, when the user is subscribing to the content, it may mean that the user may execute, view, or play the content by periodically paying a certain amount of money; when the user has purchased the content, it may mean that the user has an authority to permanently execute the content; when the user has rented the content, it may mean that the user may execute, view, or play the content for a certain period of time; and when the user is able to subscribe to the content for free, it may mean the content is public content that anyone may execute for free.

The electronic device 100 according to an embodiment of the present disclosure may predict application subscription information and application preference information of the user based on the predicted content viewing history for each content provider and the predicted license information of the user for each content, and may recommend content to the user according to a prediction result. How the additionally obtained information is used for content recommendation will be described in detail later.

In an embodiment of the present disclosure, the content selection information of the user, the execution request information for the application of the content provider providing the selected content, the start and termination information of the application, the operation information of the codec for executing the selected content, information on execution of the screen saver, and on/off information of the content playback device may be obtained from device log information.

In the present disclosure, “log information” may refer to information stored in a log file in which various events occurring in the electronic device are recorded in chronological order. For example, the device log information may include information on network access, login, file modification, power on/off, authorization, system change, command execution, and the like. The device log information may include the content selection information of the user, the execution request information for the application of the content provider that provides the selected content, the start and termination information of the application, the operation information of the codec for executing the selected content, the information on the execution of the screen saver, and the on/off information of the content playback device.

In FIG. 1B, the electronic device 100 is illustrated as a device different from an electronic device that is a log information acquisition target, but, in an embodiment of the present disclosure, the electronic device 100 may be the same as the electronic device that is the log information acquisition target.

In an embodiment of the present disclosure, there may be a plurality of electronic devices that are log information acquisition targets. In an embodiment, one or more other electronic devices that are used under the same user account or determined to be used by the same user through user identification may all be log information acquisition targets.

The electronic device 100 or the electronic device that is the log information acquisition target may be implemented in various forms such as a tablet PC, a digital camera, a camcorder, a laptop computer, a netbook computer, a desktop, an e-book terminal, a video phone, a digital broadcasting terminal, a personal digital assistant (PDA), a portable multimedia player (PMP), a navigation device, a wearable device, a smart refrigerator, and other home appliances.

In particular, embodiments may be easily implemented in an electronic device including a processor capable of processing a large amount of data, such as a server, but are not limited thereto. In addition, the electronic device 100 may be fixed or mobile, and may be a digital broadcast receiver capable of receiving digital broadcasts.

The electronic device 100 may include a display, but is not limited thereto, and may be implemented in a form that operates by being connected to an external display even if the display is not included.

For example, the electronic device 100 may be implemented in a form of outputting an image to a separate external display through a video or audio output port in a state where there is no display or there is a simple display for notification, such as an STB or an Apple TV.

In this case, the electronic device 100 may include an output port for outputting a video or audio signal to the display. The output port may be a form capable of simultaneously transmitting a video signal and an audio signal, such as HDMI, DP, Thunderbolt, or the like, or a form in which ports for separately transmitting a video signal and an audio signal exist.

In an embodiment, the electronic device 100 may transmit a video or audio signal through wired communication or wireless communication.

The electronic device 100 may be implemented not only as an electronic device in which a display is flat, but also as an electronic device in which a display is curved with a curvature or a flexible electronic device capable of adjusting a curvature. The output resolution of the electronic device 100 may include, for example, high definition (HD), Full HD, Ultra HD, or resolution higher than Ultra HD.

In the present disclosure, a database 101 for storing log information and a database 102 for storing metadata information of content obtained from a plurality of content providers may be a storage embedded in the electronic device 100 or a storage separately existing outside.

The metadata information of the content may be periodically obtained from the plurality of content providers and updated.

The electronic device 100 according to an embodiment of the present disclosure may improve the accuracy of prediction for the content viewing history for each content provider, the license information of the user for content, the application subscription information of the user, and the application preference information by using the additional device log information, may provide accurate content recommendation, and may establish profiling information for each user.

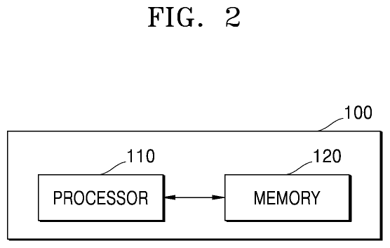

FIG. 2 is a block diagram illustrating a configuration of an electronic device according to an embodiment of the present disclosure.

Referring to FIG. 2, the electronic device 100 may include a processor 110 and a memory 120.

The memory 120 may store a program for processing and control of the processor 110. In addition, the memory 120 may store data input to the electronic device 100 or output from the electronic device 100.

The memory 120 may include at least one of an internal memory (not shown) and an external memory (not shown).

The memory 120 may include at least one type of storage medium among a flash memory type, a hard disk type, a multimedia card micro type, a card type memory (e.g., SD or XD memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, and an optical disk.

The internal memory may include, for example, at least one of a volatile memory (e.g., a dynamic RAM (DRAM), a static RAM (SRAM), a synchronous dynamic RAM (SDRAM), etc.), a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, etc.), a hard disk drive (HDD), or a solid state drive (SSD).

According to an embodiment, the processor 110 may load a command or data received from at least one of the non-volatile memory or other components into the volatile memory and process the command or data. In addition, the processor 110 may store data received or generated from other components in the non-volatile memory.

The external memory may include, for example, at least one of a compact flash (CF), a secure digital (SD), a micro secure digital (Micro-SD), a mini secure digital (Mini-SD), an extreme digital (xD), and a memory stick.

The memory 120 may store one or more instructions executable by the processor 110.

In an embodiment, the memory 120 may store various types of information input through an input/output unit (not shown).

In an embodiment, the memory 120 may store instructions for controlling the processor to obtain session information for each content viewing of a user and metadata for each content, predict a content viewing history for each content provider based on the session information, predict license information of the user for each content based on the content viewing history for each content provider and the metadata information, and recommend content according to application subscription information and application preference information of the user determined based on the content viewing history for each content provider and the license information.

In the present disclosure, “session information” may refer to information related to content execution among log information from a time point of obtaining a user input for selecting content to a time point of ending viewing of the selected content.

In an embodiment, the session information may include at least one of user input information for selecting one content from among a plurality of pieces of recommended content, execution request information for an application of a content provider providing the selected content, information on start and termination of the application, information on an operation of a codec for executing the selected content, power on/off information of the electronic device, and operation information of a screen saver.

When there is a user input or a preset and stored condition is satisfied, the processor 110 may execute an operating system (OS) and various applications stored in the memory 120.

The processor 110 may include a random access memory (RAM) that stores signals or data input from the outside of the electronic device 100 or is used as a storage area corresponding to various operations performed by the electronic device 100, and a read-only memory (ROM) that stores a control program for controlling the electronic device 100.

The processor 110 may include a single core, a dual core, a triple core, a quad core, and a multiple core thereof. In addition, the processor 110 may include a plurality of processors. For example, the processor 110 may be implemented as a main processor (not shown) and a sub-processor (not shown) operating in a sleep mode.

In addition, the processor 110 may include at least one of a central processing unit (CPU), a graphics processing unit (GPU), and a video processing unit (VPU). Alternatively, according to an embodiment, the processor 110 may be implemented in the form of a system on chip (SOC) in which at least one of the CPU, the GPU, and the VPU is integrated.

The processor 110 may control various components of the electronic device 100 by executing one or more instructions stored in the memory 120.

In an embodiment, the processor 110 may obtain session information for each content viewing of a user and metadata for each content. In an embodiment, the processor 110 may predict a content viewing history for each content provider based on the session information. In an embodiment, the processor 110 may predict license information of the user for each content based on the content viewing history for each content provider and metadata information. In an embodiment, the processor 110 may recommend content according to application subscription information and application preference information of the user determined based on the content viewing history for each content provider and the license information.

In an embodiment, the processor 110 may execute one or more instructions to, when power of the electronic device is turned off or a screen saver is operated, determine that a session has been terminated.

In an embodiment, the processor 110 may execute one or more instructions to, when there exist user input information for selecting one content from among a plurality of pieces of recommended content, execution request information for an application of a content provider providing the selected content, and information on start of the application, and a codec for executing the selected content operates for a certain period of time or longer, predict that the selected content provided by the content provider has been viewed.

In an embodiment, the processor 110 may execute one or more instructions to predict license information of the user for each content as one of free, subscription, rental, and purchase based on the content viewing history for each content provider of the user predicted based on the session information and the metadata information.

In an embodiment, the processor 110 may execute one or more instructions to, when a plurality of content providers provide the same content redundantly, determine a recommendation priority based on the application subscription information and the application preference information of the user.

In an embodiment, the processor 110 may execute one or more instructions to determine content of a content provider determined to be subscribed to by the user as a priority based on the application subscription information of the user, and determine the recommendation priority based on the application preference information when the application subscription information of the user is the same.

In an embodiment, the application preference information may be determined based on the number of selections for each content provider, an average viewing time, and a viewing time for each content.

In an embodiment, the application preference information may be determined according to a score calculated by applying a weight to at least one of the number of selections for each content provider, the average viewing time, and the viewing time for each content. This will be described in detail later.

In an embodiment, the processor 110 may transmit a video signal or an audio signal transmitted from the electronic device 100 to an external display so that the corresponding signal is output to the external display.

In an embodiment, the processor 110 may receive a priority of content recommendation determined by a server and may control the electronic device 100 to recommend content.

The processor 110 may receive recommended content from the server and may control the electronic device 100 to display the recommended content.

In an embodiment, the processor 110 may obtain session information for each content viewing of a user and metadata for each content from the server, predict a content viewing history for each content provider based on the obtained session information, predict license information of the user for each content based on the predicted content viewing history for each content provider and metadata information obtained from the server, and control to recommend content according to application subscription information and application preference information of the user determined based on the content viewing history for each content provider and the license information.

In an embodiment, the processor 110 may obtain session information for each content viewing of a user and metadata for each content from the server, and may perform at least one of a task of predicting a content viewing history for each content provider based on the session information, a task of predicting license information of the user for each content based on the predicted content viewing history for each content provider and obtained metadata information, and a task of recommending content according to application subscription information and application preference information of the user determined based on the content viewing history for each content provider and the license information. In this case, a task not performed by the processor 110 may be performed in the server and shared with the processor 100.

The tasks executed by the processor 110 will be described in detail later.

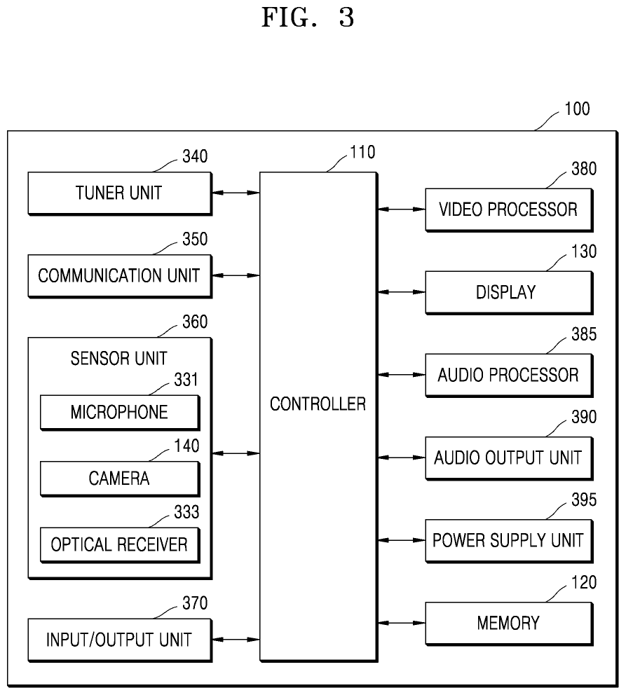

FIG. 3 is a block diagram for describing in more detail a configuration of an electronic device according to another embodiment of the present disclosure.

The electronic device 100 of FIG. 3 may be an example of the electronic device 100 described with reference to FIGS. 1 and 2.

Referring to FIG. 3, the electronic device 100 may include a tuner unit 340, the processor 110, a display 320, a communication unit 350, a sensor unit 130, an input/output unit 370, a video processor 380, an audio processor 385, an audio output unit 390, the memory 120, and a power supply unit 395.

The processor 110 of FIG. 3 corresponds to the processor 110 of FIG. 2, and the memory 120 of FIG. 3 corresponds to the memory 120 of FIG. 2. Therefore, the same description as that made above will be omitted.

The communication unit 350 according to an embodiment may include a Wi-Fi module, a Bluetooth module, an infrared communication module, a wireless communication module, a LAN module, an Ethernet module, a wired communication module, and the like. In this case, each communication module may be implemented in the form of at least one hardware chip.

The Wi-Fi module and the Bluetooth module perform communication in a Wi-Fi method and a Bluetooth method, respectively. When the Wi-Fi module or the Bluetooth module is used, various types of connection information such as an SSID and a session key may be transmitted and received first, communication may be connected using the various types of connection information, and then various types of information may be transmitted and received. The wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G), and the like.

The communication unit 350 according to an embodiment may receive a user input from an external device 300 such as a user device.

The communication unit 350 according to an embodiment may communicate with an external device such as a server.

The communication unit 350 according to an embodiment may include a communication unit configured to perform wireless communication such as BT with a server or the like and a communication unit connected to an external device such as a HDMI port or the like. In this case, the communication unit that performs wireless communication such as BT with the server or the like may perform connection with another device and video/audio data transmission. The communication unit connected to the external device through the HDMI port or the like may include not only an input port for receiving an input, but also an output port such as DP, HDMI, RGB, DVI, Thunderbolt, or the like for transmitting a video or audio signal to an external display or a speaker.

The tuner unit 340 according to an embodiment may tune and select only a frequency of a channel to be received by the broadcast receiving device 100 among many radio wave components through amplification, mixing, and resonance of a broadcast signal received in a wired or wireless manner. The broadcast signal includes audio, video, and additional information (e.g., an electronic program guide (EPG)).

The tuner unit 340 may receive a broadcast signal from various sources such as terrestrial broadcasting, cable broadcasting, satellite broadcasting, Internet broadcasting, etc. The tuner unit 340 may receive a broadcast signal from a source such as analog broadcasting or digital broadcasting.

The sensor unit 130 may detect a voice around the electronic device 100, an image around the electronic device 100, or an interaction with the electronic device 100, and may include at least one of a microphone 331, a camera 332, and an optical receiver 333. The sensor unit 130 may detect a state of the electronic device 100 or a state around the electronic device 100, and may transmit the detected information to the processor 110.

The microphone 331 receives a user's uttered voice and a voice generated around the electronic device 100. The microphone 331 may convert the received voice into an electrical signal and may output the electrical signal to the processor 110. The microphone 331 may use various noise removal algorithms for removing noise generated in a process of receiving an external sound signal.

The camera 332 may obtain an image frame such as a still image or a moving image. An image captured through an image sensor may be processed through the processor 110 or a separate image processor (not shown).

The image frame processed by the camera 332 may be stored in the memory 120 or may be transmitted to the outside through the communication unit 350. Two or more cameras 332 may be provided according to a configuration of the electronic device 100.

The optical receiver 333 receives an optical signal (including a control signal) received from an external remote control device (not shown). The optical receiver 333 may receive an optical signal corresponding to a user input (e.g., touch, press, touch gesture, voice, or motion) from the remote control device (not shown). A control signal may be extracted from the received optical signal under the control of the processor 110. For example, the optical receiver 333 may receive a control signal corresponding to a channel up/down button for channel switching from the remote control device (not shown).

Although the sensor unit 130 of FIG. 3 is illustrated as including the microphone 331, the camera 332, and the optical receiver 333, the present disclosure is not limited thereto, and the sensor unit 130 may include at least one of a magnetic sensor, an acceleration sensor, a temperature/humidity sensor, an infrared sensor, a gyroscope sensor, a position sensor (e.g., a GPS), an atmospheric pressure sensor, a proximity sensor, an RGB sensor, an illuminance sensor, and a Wi-Fi signal receiver, but is not limited thereto. Because the function of each sensor may be intuitively inferred by those skilled in the art from its name, a detailed description thereof will be omitted.

Although the sensor unit 130 of FIG. 3 is illustrated as being provided in the electronic device 100 itself, the present disclosure is not limited thereto, and the sensor unit 130 may be provided in a control device that is located independently of the electronic device 100 such as a remote controller and communicates with the electronic device 100. When the sensor unit 130 is provided in the control device of the electronic device 100, the control device may digitize information sensed by the sensor unit 130 and may transmit the digitized information to the electronic device 100. The control device may communicate with the electronic device 100 by using short-range communication including infrared, Wi-Fi, or Bluetooth.

For example, the microphone may be provided in the electronic device 100 itself, but may also be provided in a control device that is located independently of the electronic device 100 and communicates with the electronic device 100, such as a remote controller.

In an embodiment, when the microphone is provided in the remote controller, an analog voice signal may be received through the microphone, and the remote controller may digitize the received analog voice signal and may transmit the digitized analog voice signal to the electronic device 100 such as a TV. In this case, the remote controller may communicate with the electronic device 100 by using short-range communication including infrared, Wi-Fi, Bluetooth, or BT.

In an embodiment, the electronic device 100 may include a plurality of communication units 350 capable of various short-range communications including infrared, Wi-Fi, or Bluetooth.

In an embodiment, the electronic device 100 may include a plurality of communication units 350 in which a communication unit communicating with a server and a communication unit communicating with a remote controller are different from each other. For example, the communication unit communicating with the server may be a communication unit using an Ethernet modem, a Wi-Fi module, or the like, whereas the communication unit communicating with the remote controller may be a communication unit using a BT module.

In an embodiment, the electronic device 100 may include the communication unit 350 in which a communication unit communicating with a server and a communication unit communicating with a remote controller are the same as each other. For example, both the communication unit communicating with the server and the communication unit communicating with the remote controller may be communication units using a Wi-Fi module.

In an embodiment, a device such as a smartphone in which a remote control application is installed may perform the same role as the remote controller described above. That is, the device in which the remote control application is installed may control the electronic device 100 such as a TV and may perform a voice recognition function.

The device in which the remote control application may be installed may be any device that may operate by installing an application, such as an AI speaker, in addition to a smartphone.

In an embodiment, the device in which the remote control application is installed may receive a user voice.

In an embodiment, the electronic device 100 may include a plurality of communication units capable of implementing the communication method to transmit and receive data to and from a device in which a remote controller or a remote control application may be installed by using Wi-Fi, BT, infrared, or the like, and to control the device in which the remote controller or the remote control application may be installed.

The input/output unit 370 receives video (e.g., a moving image, etc.), audio (e.g., voice, music, etc.), and additional information (e.g., EPG, etc.) from the outside of the electronic device 100 under the control of the processor 110. The input/output unit 370 may include any one of a high-definition multimedia interface (HDMI), a mobile high-definition link (MHL), a universal serial bus (USB), a display port (DP), a Thunderbolt port, a video graphics array (VGA) port, an RGB port, a D-subminiature (D-SUB), a digital visual interface (DVI), a component jack, and a PC port.

The video processor 380 processes video data received by the electronic device 100. The video processor 380 may perform various types of image processing, such as decoding, scaling, noise filtering, frame rate conversion, resolution conversion, etc., on the video data.

The display 320 generates a driving signal by converting an image signal, a data signal, an on-screen display (OSD) signal, a control signal, or the like processed by the processor 110. The display 320 may be implemented as a plasma display panel (PDP), a liquid crystal display (LCD), an organic light-emitting diode (OLED), a flexible display, or the like, and may also be implemented as a three-dimensional (3D) display. In addition, the display 320 may be configured as a touch screen and used as an input device in addition to an output device.

The display 320 may output various content input through a communication unit (not shown) or the input/output unit 370, or may output an image stored in the memory 120. In addition, the display 320 may output information input by a user through the input/output unit 370 on a screen.

The display 320 may include a display panel. The display panel may be a liquid crystal display (LCD) panel or a panel including various light emitters such as a light-emitting diode (LED), an organic light-emitting diode (OLED), a cold cathode fluorescent lamp (CCFL), etc. In addition, the display panel may include not only a flat display device, but also a curved display device having a screen having a curvature or a flexible display device having an adjustable curvature. The display panel may be a three-dimensional (3D) display or an electrophoretic display.

An output resolution of the display panel may include, for example, high definition (HD), Full HD, Ultra HD, or a resolution higher than Ultra HD.

In the embodiment of FIG. 3, the electronic device 100 is illustrated as including the display, but is not limited thereto. The electronic device 100 may be connected to a separate display device including a display through wired/wireless communication and configured to transmit a video/audio signal to the display device.

The audio processor 385 processes audio data. The audio processor 385 may perform various types of processing, such as decoding, amplification, noise filtering, etc., on the audio data. Meanwhile, the audio processor 385 may include a plurality of audio processing modules to process audio corresponding to a plurality of pieces of content.

The audio output unit 390 outputs audio included in a broadcast signal received through the tuner unit 340 under the control of the processor 110. The audio output unit 390 may output audio (e.g., voice or sound) input through the communication unit 350 or the input/output unit 370. In addition, the audio output unit 390 may output audio stored in the memory 120 under the control of the processor 110. The audio output unit 390 may include at least one of a speaker, a headphone output terminal, or a Sony/Philips Digital Interface (S/PDIF) output terminal.

The power supply unit 395 supplies power input from an external power source to internal components of the electronic device 100 under the control of the processor 110. In addition, the power supply unit 395 may supply power output from one or two or more batteries (not shown) located inside the electronic device 100 to the internal components under the control of the processor 110.

The memory 120 may store various data, programs, or applications for driving and controlling the electronic device 100 under the control of the processor 110. The memory 120 may include a broadcast receiving module, a channel control module, a volume control module, a communication control module, a voice recognition module, a motion recognition module, an optical receiving module, a display control module, an audio control module, an external input control module, a power control module, a power control module of an external device connected wirelessly (e.g., Bluetooth), a voice database (DB), or a motion DB, which are not shown. The modules and the databases of the memory 120, which are not shown, may be implemented in the form of software to perform, in the electronic device 100, a broadcast reception control function, a channel control function, a volume control function, a communication control function, a voice recognition function, a motion recognition function, an optical reception control function, a display control function, an audio control function, an external input control function, a power control function, or a power control function of an external device connected wirelessly (e.g., via Bluetooth). The processor 110 may perform each function by using the software stored in the memory 120.

Meanwhile, the block diagrams of the electronic device 100 illustrated in FIGS. 2 and 3 are block diagrams for an embodiment. Each component of the block diagram may be integrated, added, or omitted according to specifications of the electronic device 100 actually implemented. That is, two or more components may be integrated into one component, or one component may be divided into two or more components as necessary. In addition, a function performed by each block is for describing embodiments, and a specific operation or device thereof does not limit the scope of the present disclosure.

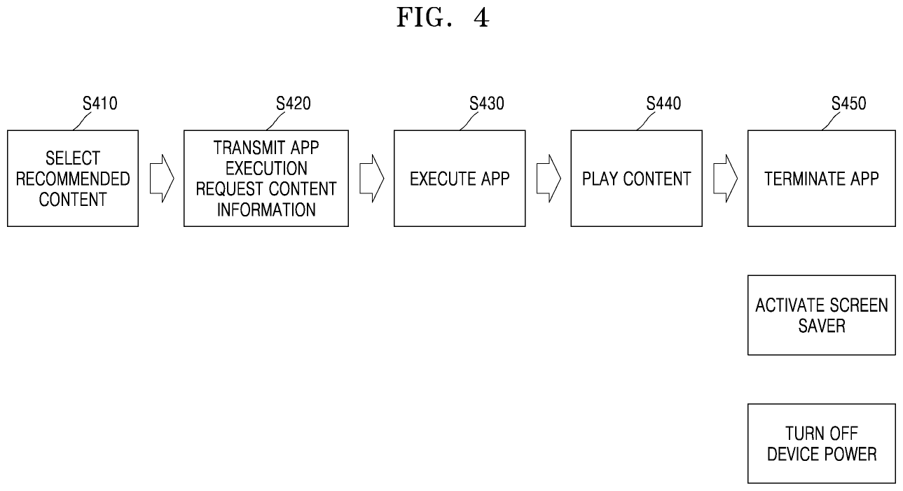

FIG. 4 is a diagram illustrating an example of session information according to an embodiment of the present disclosure.

In an embodiment, session information may include at least one of user input information for selecting one content from among a plurality of pieces of recommended content, execution request information for an application of a content provider providing the selected content, information on start and termination of the application, information on an operation of a codec for executing the selected content, power on/off information of an electronic device, or operation information of a screen saver.

In the embodiment of FIG. 4, the session information may include information on a series of processes in which the electronic device 100 receives user input information for selecting one content from among a plurality of pieces of recommended content (S410), requests execution of an application providing the selected content and transmits the selected content information (S420), executes or starts the application providing the selected content (S430), plays or executes the selected content (S440), and terminates execution of the application providing the selected content (S450).

In this case, the user input for selecting one content may be an example of the user input for selecting content.

In an embodiment of the present disclosure, the user input may be received through various input means. The user input may be one of a voice input, a touch input, a gesture input, an input through an input interface such as a remote controller, a keyboard, or a mouse, or a text input.

In an embodiment of the present disclosure, when the user input is a voice input, the voice input may be received through a microphone embedded in the electronic device 100 itself, or may be received through a microphone in a remote controller or a smartphone serving as a remote controller.

In an embodiment of the present disclosure, when the voice input is received through the microphone embedded in the electronic device 100 itself, an analog voice signal may be digitized and transmitted to the processor 110.

In an embodiment of the present disclosure, when the voice input is received through the microphone embedded in the electronic device 100 itself, the voice input may be transmitted to a separate server, converted into text, and then received by the electronic device 100.

In an embodiment of the present disclosure, when the voice input is received through the microphone in the remote controller, the smartphone serving as the remote controller, or a content playback device separate from the electronic device 100, a received analog voice signal may be digitized and transmitted to the electronic device 100 through BT or the like, or the received analog voice signal may be transmitted to the electronic device 100 and digitized.

In an embodiment of the present disclosure, a session may start at a time point when user input information for selecting one content from among a plurality of pieces of recommended content is received, and may be terminated at a time point when execution of an application providing the selected content is terminated.

In an embodiment of the present disclosure, the session may be terminated when a screen saver is operated or power is turned off, even if the execution of the application providing the selected content is not terminated.

In an embodiment of the present disclosure, when the screen saver is operated or the power is turned off, the electronic device 100 may consider that the execution of the application providing the selected content is terminated.

When the power is turned off while viewing the content, information that has not yet been stored among the corresponding session information may be lost.

In an embodiment of the present disclosure, at a time point when the power is turned off and then applied again, the electronic device 100 may recognize that the power is turned off for a previous session, and may store a time point when session information storage is stopped as a session termination time point.

In an embodiment of the present disclosure, at a time when the power is turned off and then applied again, the electronic device 100 may recognize that the power is turned off for the previous session by identifying that a global session value is increased. In an embodiment, the global session value may be a value that is automatically increased when one session is newly started.

In an embodiment of the present disclosure, when it is recognized that the power is turned off, the electronic device 100 may delete all information of the corresponding session.

In an embodiment of the present disclosure, a series of processes of receiving user input information for selecting one content from among a plurality of pieces of recommended content (S410), requesting execution of an application providing the selected content, transmitting the selected content information (S420), executing or starting the application providing the selected content (S430), playing or executing the selected content (S440), and terminating the execution of the application providing the selected content (S450) may occur in order.

In an embodiment of the present disclosure, the series of processes of receiving user input information for selecting one content from among a plurality of pieces of recommended content (S410), requesting execution of an application providing the selected content, transmitting the selected content information (S420), executing or starting the application providing the selected content (S430), playing or executing the selected content (S440), and terminating the execution of the application providing the selected content (S450) may be stored in a database as times of different time zones as a time zone in which a device, which is an object of log information collection, exists is changed, and in this case, because an occurrence order of each event may be changed, the electronic device 100 may change a time at which each event occurs into a universal time (UTC time) and then may store the time in the database.

In an embodiment of the present disclosure, only when user input information for selecting one content from among a plurality of pieces of recommended content is received (S410), execution of an application providing the selected content is requested and the selected content information is transmitted (S420), and then the application is executed or started (S430) within a certain time, the electronic device 100 may determine that the execution or start of the application is valid. In this case, the certain time of an embodiment may be 5 seconds.

Although the recommended content is selected by setting a time lit of within the certain time, if the application is not installed or the execution request for the application fails and a session is terminated, the electronic device 100 may filter the content.

In an embodiment of the present disclosure, only when user input information for selecting one content from among a plurality of pieces of recommended content is received (S410), execution of an application providing the selected content is requested and the selected content information is transmitted (S420), the application providing the selected content within is executed or started (S430)_within a certain time (S430), and then a codec for executing the selected content is operated for a certain time or longer, the electronic device 100 may determine the content is viewed or played. In this case, the certain time of an embodiment may be 5 minutes or more.

In an embodiment of the present disclosure, the electronic device 100 may distinguish between an operation of a codec used for an image automatically played on an application loading screen when the application starts and an operation of a codec for executing the selected content by using prior information on types of codecs.

In an embodiment of the present disclosure, the electronic device 100 may obtain information on a type of a codec used for an image automatically played on an application loading screen and a type of a codec for executing the selected content through metadata information on the content.

In an embodiment of the present disclosure, when the codec for executing the selected content is terminated as soon as the codec is operated or is terminated within a certain time, the electronic device 100 may determine that the corresponding content is not viewed or played.

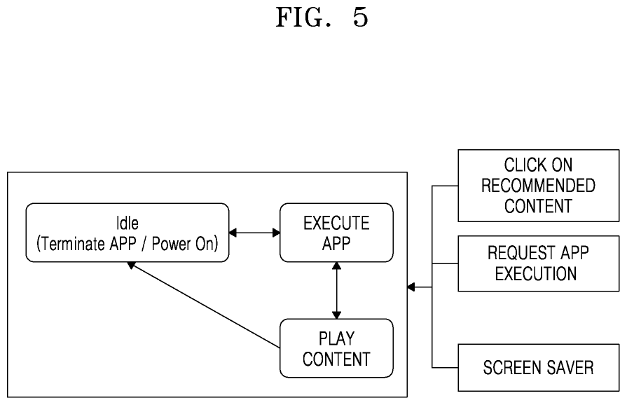

In an embodiment of the present disclosure, the series of processes of receiving user input information for selecting one content from among a plurality of pieces of recommended content (S410), requesting execution of an application providing the selected content, transmitting the selected content information (S420), executing or starting the application providing the selected content (S430), playing or executing the selected content (S440), and terminating the execution of the application providing the selected content (S450) may not occur in order. This will be described later with reference to FIG. 5.

FIG. 5 is a diagram illustrating an example of a session information flow according to an embodiment of the present disclosure.

In an embodiment of the present disclosure, a series of processes of receiving user input information for selecting one content from among a plurality of pieces of recommended content, requesting execution of an application providing the selected content, transmitting the selected content information, executing or starting the application providing the selected content, playing or executing the selected content, and terminating the execution of the application providing the selected content may not occur in order.

Accordingly, if it is determined as a normal session only when events occur in the order of the above series of processes, a session omitted in the middle may occur.

In an embodiment, there may be a case where, in a state where an application is first executed, user input information for selecting one content from among a plurality of pieces of recommended content is received, execution of the application providing the selected content is requested, and the selected content information is transmitted to the application. In this case, even if the order is different, when user input information for selecting one content among the plurality of pieces of recommended content is received, the application providing the selected content is executed, the selected content information is transmitted to the application, and a codec for executing the application is operated for a certain time or longer, the electronic device 100 may recognize that a session starts normally and the selected content is played or viewed, and may store each event as a part of session information.

In an embodiment, the electronic device 100 may store the session information by updating an application execution time to a time point when the user input information for selecting one content from among the plurality of pieces of recommended content is received, the execution of the application providing the selected content is requested, and the selected content information is transmitted to the application.

In an embodiment, there may be a case where, while an application is already executed and first content is being played, user input information for selecting second content from among a plurality of pieces of recommended content is received, execution of the application providing the selected second content is requested, and the selected second content information is transmitted to the application. Even in this case, even if the order is different, when user input information for selecting the second content among the plurality of pieces of recommended content is received, the application providing the second content is executed, the second content information is transmitted to the application, and the second content is executed for a certain time or longer, the electronic device 100 may recognize that a session starts normally and the second content is viewed or played, and may store each event as session information. In this case, the electronic device 100 may store the session information by updating an application execution time point to a time point when the user input information for selecting the second content among the plurality of pieces of recommended content is received, the execution of the application providing the selected second content is requested, and the selected second content information is transmitted to the application.

In an embodiment, when, at any one time point in a process in which an application is executed and content is played, user input information for selecting one content from among a plurality of pieces of recommended content is received, execution of the application providing the selected content is requested, and the selected content information is transmitted to the application, the electronic device 100 may regard the time point when the selected content information is transmitted to the application as the execution time point of the application as long as the application is not terminated.

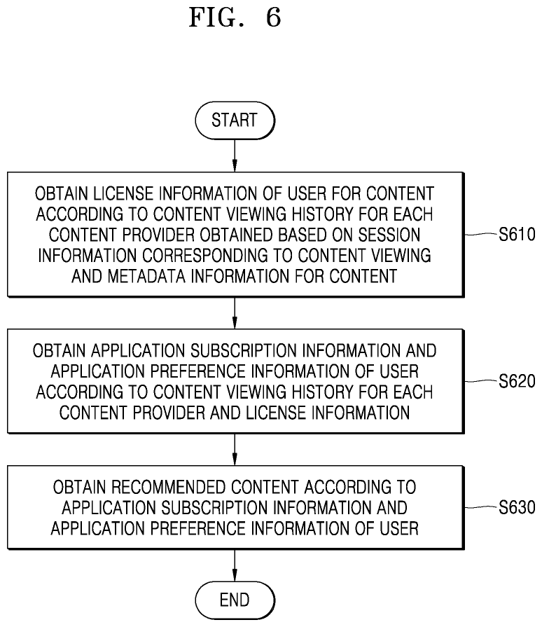

FIG. 6 is a flowchart illustrating an operating method of an electronic device according to an embodiment of the present disclosure.

Referring to FIG. 6, the electronic device 100 according to an embodiment of the present disclosure may obtain license information of a user for content according to a content viewing history for each content provider, which is obtained based on session information corresponding to content viewing, and metadata information on the content (S610).

In an embodiment, a session may refer to one interval including all viewing histories from a time point when an application is executed by selecting recommended content to a time point when the corresponding application is terminated.

Session information may refer to information related to content execution among log information from a time point when a user input for selecting content is obtained to a time point when viewing of the selected content is terminated.

In the present disclosure, “metadata information on content” may refer to detailed information on each content generated and provided by a content provider. For example, the metadata information on the content may include information on a codec for executing the content, a license type of the content, information on a content provider, and the like. The license type of the content may refer to information on whether the corresponding content is provided for free, is purchasable, is only rentable, or is only subscribable.

The electronic device 100 according to an embodiment of the present disclosure may obtain session information for each content viewing of a user and metadata information on each content from an external storage device

The electronic device 100 according to an embodiment of the present disclosure may obtain session information for each content viewing of a user and metadata information on each content from a storage device inside the device.

The electronic device 100 according to an embodiment of the present disclosure may obtain session information for each content viewing of a user and metadata information on each content from an external device.

When there exist user input information for selecting one content from among a plurality of pieces of recommended content, execution request information for an application of a content provider providing the selected content, and information indicating that the application is started or executed within a certain time after the execution request for the application, and a codec for executing the selected content is operated for a certain time or longer, the electronic device 100 according to an embodiment of the present disclosure may predict that the selected content has been viewed. In this case, the electronic device 100 according to an embodiment of the present disclosure may obtain or store information such as a date and time when the user played the content, a content playback time, and the like.

The electronic device 100 according to an embodiment of the present disclosure may predict a time during which the codec for executing the selected content is operated as a time during which the content is viewed or a time during which the content is played.

The electronic device 100 according to an embodiment of the present disclosure may obtain application subscription information and application preference information of the user according to the content viewing history for each content provider and the license information (S620).

When it is predicted that content whose license type is “subscription” among the metadata information of the content has been viewed or played, the electronic device 100 according to an embodiment of the present disclosure may predict that the user is subscribing to the content. This is because content whose license type of “subscription” may be viewed only by a user who is subscribing to the content.

When it is predicted that content whose license type is “purchase” among the metadata information of the content has been viewed or played, the electronic device 100 according to an embodiment of the present disclosure may predict that the user has purchased the content. This is because content whose license type is “purchase” may be viewed only by a user who purchased the content.

When it is predicted that content whose license type is “rental” among the metadata information of the content has been viewed or played, the electronic device 100 according to an embodiment of the present disclosure may predict that the user has rented the content. This is because content whose license type of “rental” may be viewed only by a user who rented the content.

When it is predicted that content whose license type is “free” among the metadata information of the content has been viewed or played, the electronic device 100 according to an embodiment of the present disclosure may predict that the user has viewed the content for free without purchasing, renting, or subscribing to the content. This is because content whose license type is “free” may be viewed by all users.

According to an embodiment of the present disclosure, when the metadata information of the content includes two or more types such as content having a license type of “purchase” or “rental”, content having a license type of “purchase” or “subscription”, and content having a license type of “purchase”, “rental”, or “subscription”, the electronic device 100 may predict the license information of the user for the corresponding content by referring to at least one of a metadata information change history of the corresponding content, a viewing history of other pieces of content in the same application, and license information of the user predicted for other pieces of content in the same application.

The electronic device 100 according to an embodiment of the present disclosure may obtain recommended content according to the application subscription information and the application preference information of the user (S630).

The electronic device 100 according to an embodiment of the present disclosure may recommend content according to the application subscription information and the application preference information of the user determined based on the content viewing history for each content provider and the license information.

The electronic device 100 according to an embodiment of the present disclosure may determine the application subscription information of the user based on the content viewing history for each content provider predicted for the user and the license information predicted for the user.

The electronic device 100 according to an embodiment of the present disclosure may determine that the user is subscribing to an application including a certain number or more of pieces of content for which the license information predicted for the user is “subscription”.

The electronic device 100 according to an embodiment of the present disclosure may determine that the user is subscribing to an application that includes a certain number or more of pieces of content for which the license information predicted for the user is “subscription” and has a history in which content provided by the corresponding application has been viewed or played by the user within recent days or months.

When an application includes a certain number or more of pieces of content for which the license information predicted for the user is “subscription” and has is a history in which content for which the license information predicted for the user is “subscription” has been viewed or played through the corresponding application within recent days or months, the electronic device 100 according to an embodiment of the present disclosure may determine that the user is subscribing to the corresponding application.

The electronic device 100 according to an embodiment of the present disclosure may determine the application preference information of the user based on the content viewing history for each content provider predicted for the user and the license information predicted for the user.

Based on the determined or predicted application subscription information of the user, the electronic device 100 according to an embodiment of the present disclosure may determine that content of a content provider determined to be subscribed to by the user has a higher priority than content of a content provider determined not to be subscribed to by the user.

The electronic device 100 according to an embodiment of the present disclosure may determine that content of a content provider predicted to be viewable only when the user bears an additional cost has a higher priority than content of a content provider predicted to be viewable even when the user does not bear an additional cost.

The electronic device 100 according to an embodiment of the present disclosure may determine that content of a content provider predicted to be viewable when the user bears a smaller additional cost has a higher priority than content of a content provider predicted to be viewable when the user needs to bear a larger additional cost.

The electronic device 100 according to an embodiment of the present disclosure may determine that content of a content provider predicted to allow the user to obtain more rights by bearing the same additional cost has a higher priority than content of a content provider predicted to allow the user to obtain fewer rights by bearing the same additional cost.

When the application subscription information of the user, whether the user should bear an additional cost, a cost to be borne by the user, and rights obtainable by bearing the same cost are the same, the electronic device 100 according to an embodiment of the present disclosure may determine a recommendation priority based on the application preference information of the user.

The electronic device 100 according to an embodiment of the present disclosure may determine the application preference information based on the number of selections for each content provider for each content, an average viewing time, and a viewing time for each content.

The electronic device 100 according to an embodiment of the present disclosure may determine the application preference information based on a score calculated based on the number of selections for each content provider, the average viewing time, and the viewing time for each content.

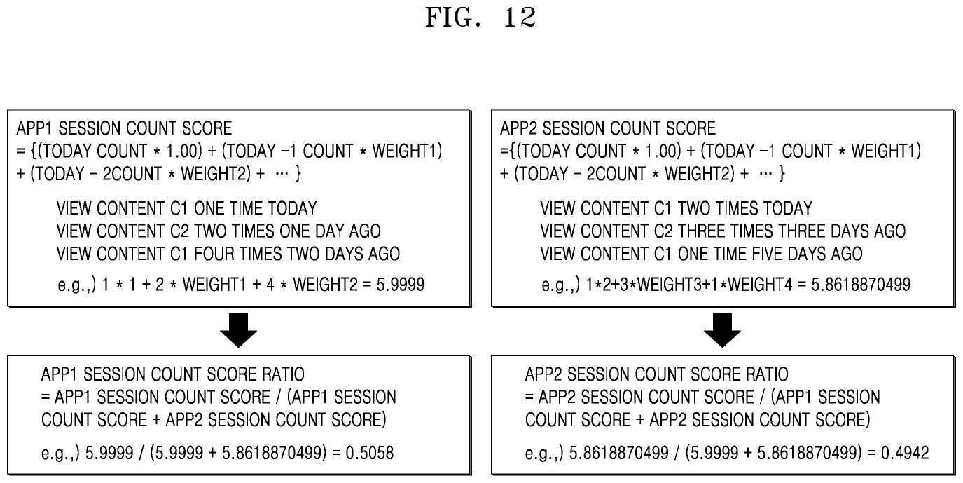

The electronic device 100 according to an embodiment of the present disclosure may determine the application preference information based on a score calculated by applying a weight to at least one of the number of selections for each content provider, the average viewing time, and the viewing time for each content. This will be described in detail later with reference to FIGS. 12 to 14.

When a plurality of content providers provide the same content redundantly, the electronic device 100 according to an embodiment of the present disclosure may determine a recommendation priority for each content provider based on the determined application subscription information and application preference information of the user.

When a plurality of content providers provide the same content redundantly, the electronic device 100 according to an embodiment of the present disclosure may determine a recommendation priority for each content provider based on the inferred or determined application subscription information and application preference information of the user.

When a plurality of content providers provide the same content redundantly, the electronic device 100 according to an embodiment of the present disclosure may determine a recommendation priority for each application based on the inferred or determined application subscription information and application preference information of the user.

When a plurality of content providers provide the same content redundantly, the electronic device 100 according to an embodiment of the present disclosure may 1) preferentially recommend content of an application determined to be subscribed to by the user based on the inferred or determined application subscription information of the user, 2) determine a recommendation priority for each application based on the application preference information when ranks according to 1) are the same, 3) determine a priority according to a license type of the corresponding content when ranks according to 1) and 2) are the same, and 4) determine a priority according to popularity of the corresponding content provider when ranks according to 1), 2) and 3) are the same.

The electronic device 100 according to an embodiment of the present disclosure may recommend content to the user according to the determined recommendation priority for each content provider.

The electronic device 100 according to an embodiment of the present disclosure may recommend content to the user according to the determined recommendation priority for each application.

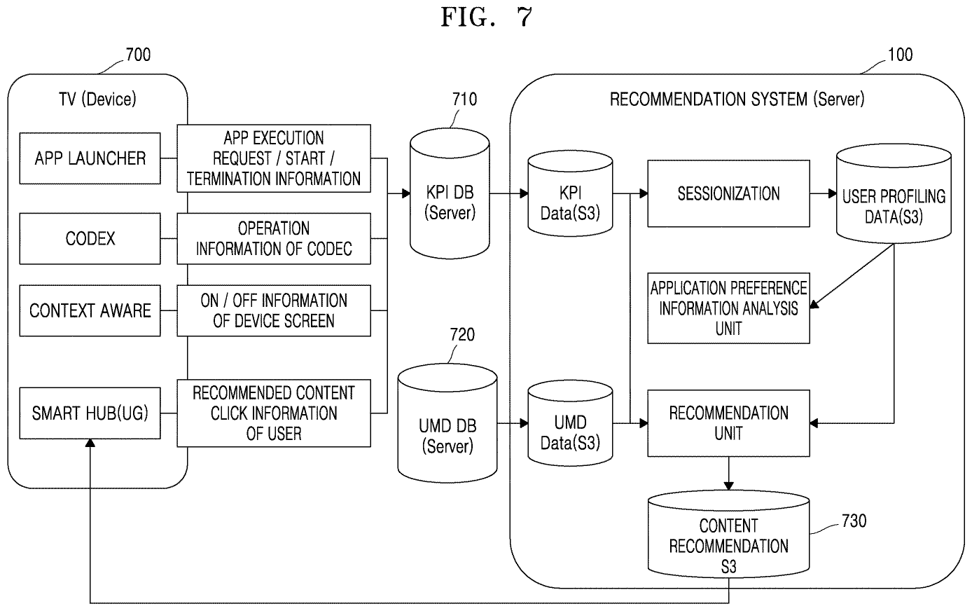

FIG. 7 is a flowchart illustrating an example of recommending content when an electronic device is a server according to an embodiment of the present disclosure;

A system according to an embodiment of the present disclosure may include a client device 700 including a content playback device such as a TV, and the electronic device 100. In the system according to an embodiment of the present disclosure, the client device 700 may be a device log acquisition target device of FIG. 1B. The electronic device 100 may be a server.

The client device 700 according to an embodiment of the present disclosure may obtain information on a user input for selecting content through a program module such as a recommendation service. In an embodiment, the information on the user input for selecting content may be information indicating that a user selects one content from among pieces of recommended content.

The client device 700 according to an embodiment of the present disclosure may request execution of an application that provides the selected content, and may execute or terminate the application that provides the selected content. A record of these events executed in the client device 700 may be obtained through a program module related to application execution, such as an application launcher.

A client device 700 according to an embodiment of the present disclosure may obtain operation information of a codec that executes or plays the selected content through a program module related to an operation of the codec, such as a codex.

The client device 700 according to an embodiment of the present disclosure may obtain power on/off information of the client device 700 through a program module related to power on/off of the device, such as a power manager.

The client device 700 according to an embodiment of the present disclosure may store, in a KPI database 710, the information on the user input for selecting content, the obtained information related to the execution of the application, the information related to the operation of the codec, and the information related to the power on/off of the client device 700.

In an embodiment of the present disclosure, the KPI database 710 may exist inside the client device 700.

In an embodiment of the present disclosure, the KPI database 710 may exist outside the client device 700.

In an embodiment of the present disclosure, the KPI database 710 may exist in the electronic device 100.

The client device 700 according to an embodiment of the present disclosure may store, in the KPI database 710 in real time, device log information related to content execution, including the information on the user input for selecting content, the obtained information related to the execution of the application, the information related to the operation of the codec, and the information related to the power on/off of the client device 700.

The client device 700 according to an embodiment of the present disclosure may periodically store, in the KPI database 710, the device log information related to the content execution, including the information on the user input for selecting content, the obtained information related to the execution of the application, the information related to the operation of the codec, and the information related to the power on/off of the client device 700.

The electronic device 100 according to an embodiment of the present disclosure may obtain, from the KPI database 710, the device log information related to the content execution, including the information on the user input for selecting content, the obtained information related to the execution of the application, the information related to the operation of the codec, and the information related to the power on/off of the client device 700.

The electronic device 100 according to an embodiment of the present disclosure may obtain metadata information on all pieces of content provided by each application from a UMD database 720.

The UMD database 720 according to an embodiment of the present disclosure may be a database that stores metadata information on pieces of content provided by content providers. The UMD database 720 may be periodically updated by the content providers.

The UMD database 720 according to an embodiment of the present disclosure may exist inside or outside the electronic device 100.

The electronic device 100 according to an embodiment of the present disclosure may store session information for each content viewing event by using the device log information obtained from the KPI database 710 and the metadata information on each content obtained from the UMD database 720. In the present disclosure, an operation of storing session information for each content viewing period may be defined as sessionization.

The electronic device 100 according to an embodiment of the present disclosure may store the session information in a user profiling database.

An application preference information analysis unit of the electronic device 100 according to an embodiment of the present disclosure may infer or obtain application preference information of the user by using one or more pieces of session information stored in the profiling database and the metadata information on each content obtained from the UMD database 720.

The electronic device 100 according to an embodiment of the present disclosure may infer or obtain the application preference information of the user by using the one or more pieces of session information stored in the profiling database.

A recommendation unit of the electronic device 100 according to an embodiment of the present disclosure may recommend one or more pieces of content to the user by using the one or more pieces of session information stored in the profiling database and the metadata information on each content obtained from the UMD database 720.

The electronic device 100 according to an embodiment of the present disclosure may recommend one or more pieces of content to the user by using the one or more pieces of session information stored in the profiling database and the metadata information on each content obtained from the UMD database 720.

In an embodiment of the present disclosure, the recommended content may be stored in a content recommendation database 730.

In an embodiment of the present disclosure, the recommended content stored in the recommendation database 730 may be provided to the user through the client device 700 used by the user.

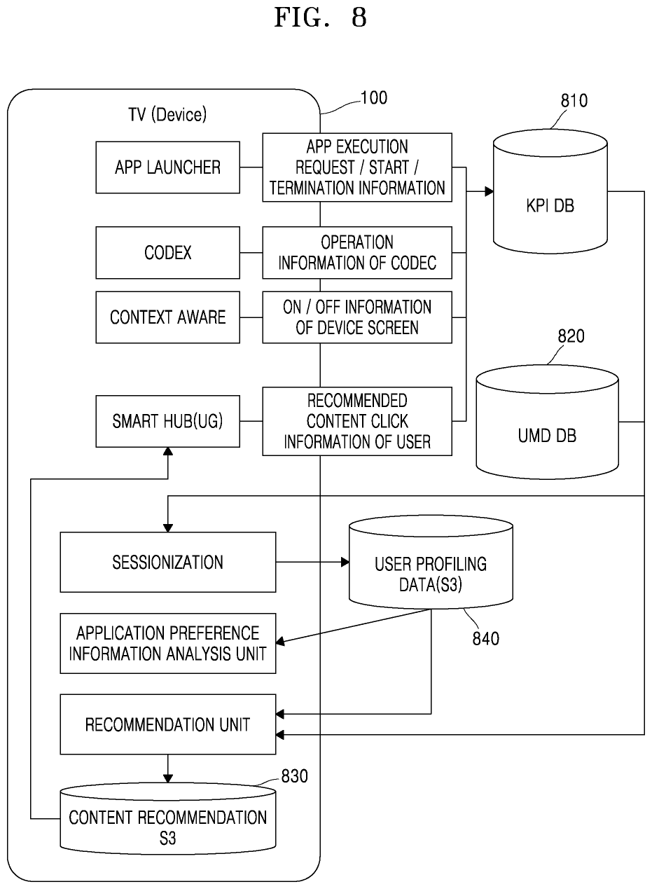

FIG. 8 is a flowchart illustrating an example of recommending content when an electronic device is an on-device type device according to an embodiment of the present disclosure.

The electronic device 100 according to an embodiment of the present disclosure may be a content playback device such as a smart TV.

The electronic device 100 according to an embodiment of the present disclosure may obtain information on a user input for selecting content through a program module such as a recommendation service. In an embodiment, the information on the user input for selecting content may be information indicating that a user selects one content from among pieces of recommended content.

The electronic device 100 according to an embodiment of the present disclosure may request execution of an application that provides the selected content, and may execute or terminate the application that provides the selected content. The electronic device 100 may obtain a record of these events executed in the electronic device 100 through a program module related to application execution, such as an application launcher.

The electronic device 100 according to an embodiment of the present disclosure may obtain operation information of a codec that executes or plays the selected content through a program module related to an operation of the codec, such as a codex.

The electronic device 100 according to an embodiment of the present disclosure may obtain power on/off information of the electronic device 100 through a program module related to power on/off of the device, such as a power manager.

The electronic device 100 according to an embodiment of the present disclosure may store, in a KPI database 810, the information on the user input for selecting content, the obtained information related to the execution of the application, the information related to the operation of the codec, and the information related to the power on/off of the electronic device 100.

In an embodiment of the present disclosure, the KPI database 810 may exist inside the electronic device 100.

In an embodiment of the present disclosure, the KPI database 810 may exist outside the electronic device 100.

The electronic device 100 according to an embodiment of the present disclosure may store, in the KPI database 810 in real time, device log information related to content execution including the information on the user input for selecting content, the obtained information related to the execution of the application, the information related to the operation of the codec, and the information related to the power on/off of the electronic device 100.

The electronic device 100 according to an embodiment of the present disclosure may periodically store, in the KPI database 810, the device log information related to the content execution including the information on the user input for selecting content, the obtained information related to the execution of the application, the information related to the operation of the codec, and the information related to the power on/off of the electronic device 100.

The electronic device 100 according to an embodiment of the present disclosure may obtain, from the KPI database 810, the device log information related to the content execution including the information on the user input for selecting content, the obtained information related to the execution of the application, the information related to the operation of the codec, and the information related to the power on/off of the electronic device 100.

The electronic device 100 according to an embodiment of the present disclosure may obtain metadata information on all pieces of content provided by each application from a UMD database 820.

The UMD database 820 according to an embodiment of the present disclosure may be a database that stores metadata information on pieces of content provided by content providers. The UMD database 820 may be periodically updated by the content providers.

The UMD database 820 according to an embodiment of the present disclosure may exist inside or outside the electronic device 100.

The electronic device 100 according to an embodiment of the present disclosure may store session information for each content viewing event by using the device log information obtained from the KPI database 810 and the metadata information on each content obtained from the UMD database 820. In the present disclosure, an operation of storing session information for each content viewing period may be defined as sessionization.

The electronic device 100 according to an embodiment of the present disclosure may store the session information in a user profiling database 840.

An application preference information analysis unit of the electronic device 100 according to an embodiment of the present disclosure may infer or obtain application preference information of the user by using one or more pieces of session information stored in the profiling database and the metadata information on each content obtained from the UMD database 820.

The electronic device 100 according to an embodiment of the present disclosure may infer or obtain the application preference information of the user by using the one or more pieces of session information stored in the profiling DB 840.

A recommendation unit of the electronic device 100 according to an embodiment of the present disclosure may recommend one or more pieces of content to the user by using the one or more pieces of session information stored in the profiling DB 840 and the metadata information on each content obtained from the UMD DB 820.

The electronic device 100 according to an embodiment of the present disclosure may recommend one or more pieces of content to the user by using the one or more pieces of session information stored in the profiling DB 840 and the metadata information on each content obtained from the UMD DB 820.

In an embodiment of the present disclosure, the recommended content may be stored in a content recommendation database 830.

In an embodiment of the present disclosure, the recommended content stored in the recommendation database 830 may be provided to the user through the electronic device 100.

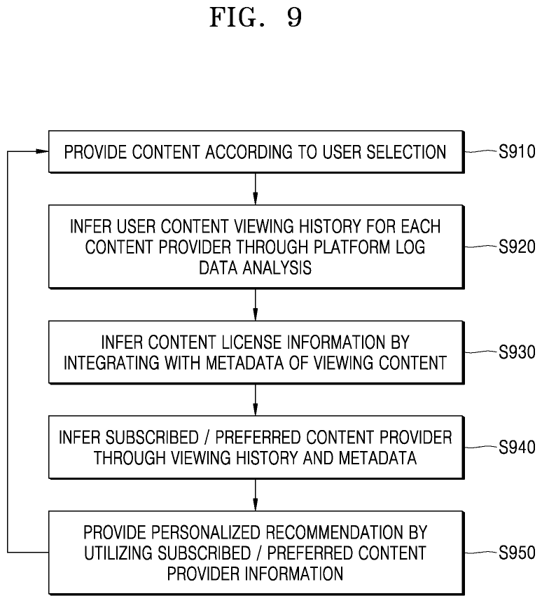

FIG. 9 is a flowchart illustrating an operating method of an electronic device according to an embodiment of the present disclosure.

The electronic device 100 according to an embodiment of the present disclosure may recommend a platform to a user to allow the user to view content (S910). The platform may refer to an application.

The electronic device 100 according to an embodiment of the present disclosure may provide the user with content selected by the user according to the user's selection to allow the user to view or play the content.

The electronic device 100 according to an embodiment of the present disclosure may sequentially store device log information related to viewing or playing of the content selected by the user. The sequentially stored device log information may be session information. The same description as that made with respect to the session information will be omitted.

The electronic device 100 according to an embodiment of the present disclosure may infer a content viewing history for each content provider of the user by analyzing platform log data, that is, the session information (S920).

When there exist user input information for selecting one content from among a plurality of pieces of recommended content, execution request information for an application of a content provider providing the selected content, and information indicating that the application is started or executed within a certain time after the execution request for the application, and a codec for executing the selected content is operated for a certain time or longer, the electronic device 100 according to an embodiment of the present disclosure may infer that the selected content provided by the content provider has been viewed.

The electronic device 100 according to an embodiment of the present disclosure may store the inferred content viewing history for the user.

The electronic device 100 according to an embodiment of the present disclosure may infer license information of the content by integrating metadata information of the content inferred to have been viewed in operation S920 (S930).

When it is inferred that content whose license type is “subscription” among the metadata information of the content has been viewed or played, the electronic device 100 according to an embodiment of the present disclosure may infer that the user is subscribing to the content.

When it is inferred that content whose license type is “purchase” among the metadata information of the content has been viewed or played, the electronic device 100 according to an embodiment of the present disclosure may infer that the user has purchased the content. This is because content whose license type is “purchase” may be viewed only by a user who purchased the content.

When it is inferred that content whose license type is “rental” among the metadata information of the content has been viewed or played, the electronic device 100 according to an embodiment of the present disclosure may infer that the user has rented the content. This is because content whose license type is “rental” may be viewed only by a user who rented the content.

When it is inferred that content whose license type is “free” among the metadata information of the content has been viewed or played, the electronic device 100 according to an embodiment of the present disclosure may infer that the user has viewed the content for free without purchasing, renting, or subscribing to the content. This is because content whose license type is “free” may be viewed by all users.

According to an embodiment of the present disclosure, when the metadata of the content includes two or more types such as content having a license type of “purchase” or “rental”, content having a license type of “purchase” or “subscription”, and content having a license type of “purchase”, “rental”, or “subscription”, the electronic device 100 may infer the license information of the user for the content by referring to at least one of a metadata information change history of the corresponding content, a viewing history of other pieces of content in the same application, and license information of the user inferred for other pieces of content in the same application.

The electronic device 100 according to an embodiment of the present disclosure may infer application subscription information of the user and a content provider preferred by the user through the content viewing history inferred for the user and the metadata information of the content (S940).

The electronic device 100 according to an embodiment of the present disclosure may infer or predict the application subscription information of the user based on the content viewing history for each content provider inferred for the user and the license information inferred for the user.

The electronic device 100 according to an embodiment of the present disclosure may infer or predict that the user is subscribing to an application including a certain number or more of pieces of content for which the license information inferred for the user is “subscription”.

The electronic device 100 according to an embodiment of the present disclosure may infer or predict that the user is subscribing to an application that includes a certain number or more of pieces of content for which the license information inferred for the user is “subscription” and has a history in which content provided by the corresponding application has been viewed or played by the user within a certain time.

When an application includes a certain number or more of pieces of content for which the license information inferred for the user is “subscription” and has a history in which content for which the license information inferred for the user is “subscription” has been viewed or played through the corresponding application within a certain time, the electronic device 100 according to an embodiment of the present disclosure may infer or predict that the user is subscribing to the corresponding application.

The electronic device 100 according to an embodiment of the present disclosure may infer or predict application preference information of the user based on the content viewing history for each content provider inferred for the user and the license information inferred for the user.

The electronic device 100 according to an embodiment of the present disclosure may determine content of a content provider determined to be subscribed to by the user as a priority, based on the determined or inferred application subscription information of the user.

When the application subscription information of the user is the same, the electronic device 100 according to an embodiment of the present disclosure may determine a recommendation priority based on the application preference information.

The electronic device 100 according to an embodiment of the present disclosure may determine the application preference information based on the number of selections for each content provider, an average viewing time, and a viewing time for each content.

The electronic device 100 according to an embodiment of the present disclosure may determine the application preference information based on a score calculated based on the number of selections for each content provider, the average viewing time, and the viewing time for each content.

The electronic device 100 according to an embodiment of the present disclosure may determine the application preference information based on a score calculated by applying a weight to at least one of the number of selections for each content provider, the average viewing time, and the viewing time for each content. This will be described in detail later with reference to FIGS. 12 to 14.

When a plurality of content providers provide the same content redundantly, the electronic device 100 according to an embodiment of the present disclosure may determine a recommendation priority for each content provider based on the inferred or predicted application subscription information and application preference information of the user.

When a plurality of content providers provide the same content redundantly, the electronic device 100 according to an embodiment of the present disclosure may determine a recommendation priority for each application based on the inferred or determined application subscription information and application preference information of the user.

The electronic device 100 according to an embodiment of the present disclosure may provide a personalized content recommendation to the user based on the application subscription information and the application preference information of the user (S950).

The electronic device 100 according to an embodiment of the present disclosure may recommend content to the user according to the determined recommendation priority for each application.

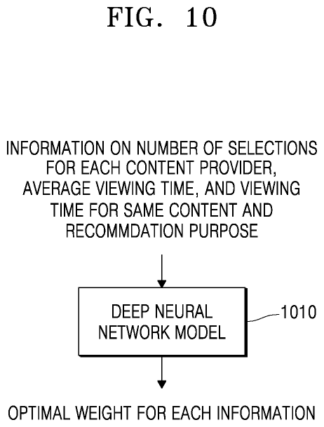

FIG. 10 is a diagram illustrating an example of a method by which an electronic device determines a weight for each item to be used for content recommendation by using artificial intelligence (AI) according to an embodiment of the present disclosure.

The electronic device 100 according to an embodiment of the present disclosure may determine application preference information of a user based on a predicted or inferred content viewing history for each content provider and license information.

The electronic device 100 according to an embodiment of the present disclosure may determine the application preference information based on the number of selections for each content provider, an average viewing time, and a viewing time for each content.

The electronic device 100 according to an embodiment of the present disclosure may determine the application preference information based on a score calculated by applying a weight to at least one of the number of selections for each content provider, the average viewing time, and the viewing time for each content.

The electronic device 100 according to an embodiment of the present disclosure may determine the application preference information by using at least one weight obtained by using a neural network trained to receive, as inputs, information on the number of selections for each content provider, the average viewing time, and the viewing time of each content, and a recommendation purpose and output a weight to be applied to at least one of the information on the number of selections for each content provider, the average viewing time, and the viewing time for each content.

The electronic device 100 according to an embodiment of the present disclosure may determine the application preference information by using at least one weight obtained by using a neural network trained to receive, as inputs, the information on the number of selections for each content provider, the average viewing time, and the viewing time for each content, and the recommendation purpose and output an optimal weight to be applied to at least one of the information on the number of selections for each content provider, the average viewing time, and the viewing time of each content.

AI is a computer system that implements human-level intelligence, in which a machine learns and judges by itself, and a recognition rate is improved as it is used. AI technology includes machine learning (deep learning) technology using an algorithm that classifies/learns features of input data by itself and element technologies that simulate functions such as cognition and judgement of a human brain by using a machine learning algorithm.

For example, the element technologies may include at least one of a linguistic understanding technology for recognizing human languages/characters, a visual understanding technology for recognizing objects like human vision, an inference/prediction technology for judging information and logically inferring and predicting the information, a knowledge representation technology for processing human experience information into knowledge data, and a motion control technology for controlling autonomous driving of a vehicle and movement of a robot.

Functions related to AI according to the present disclosure are operated through the processor 110 and the memory 120. The processor 110 may include one or more processors. In this case, the one or more processors may be a general-purpose processor such as a CPU, an AP, or a digital signal processor (DSP), a graphics-dedicated processor such as a GPU or a vision processing unit (VPU), or an AI-dedicated processor such as an NPU. The one or more processors 110 control to process input data according to a predefined operation rule or an AI model stored in the memory 120. Alternatively, when the one or more processors 110 are AI-dedicated processors, the AI-dedicated processors may be designed in a hardware structure specialized for processing a specific AI model.

The predefined operation rule or the AI model is created through learning. Here, “created through learning” means that a basic AI model is trained by a learning algorithm by using a plurality of training data so that a predefined operation rule or an AI model set to perform a desired characteristic (or purpose) is created. Such learning may be performed in the advertisement target determination device 100 itself in which AI according to the present disclosure is performed, or may be performed through a separate server 200 and/or system. Examples of the learning algorithm include supervised learning, unsupervised learning, semi-supervised learning, or reinforcement learning, but are not limited thereto.

The AI model may include a plurality of neural network layers. Each of the plurality of neural network layers has a plurality of weights (weight values), and performs a neural network operation through an operation between an operation result of a previous layer and the plurality of weights. The plurality of weights of the plurality of neural network layers may be optimized by a learning result of the AI model. For example, the plurality of weights may be updated such that a loss value or a cost value obtained from the AI model during a learning process is reduced or minimized.

In an embodiment using a deep learning algorithm, the processor 110 may determine the application preference information by using at least one weight obtained by using a pre-trained deep neural network model 1010.

The pre-trained deep neural network model 1010 may be an AI model trained through learning in which the information on the number of selections for each content provider, the average viewing time, and the viewing time of each content, and the recommendation purpose are used as input values and an optimal weight to be applied to at least one of the number of selections for each content provider, the average viewing time, and the viewing time of each content is used as an output value.

The deep neural network model may be, for example, a convolutional neural network (CNN). However, the present disclosure is not limited thereto, and the deep neural network model may be a known AI model including at least one of a recurrent neural network (RNN), a restricted Boltzmann machine (RBM), a deep belief network (DBN), a bidirectional recurrent deep neural network (BRDNN), and a deep Q-network.

The electronic device 100 may obtain an optimal weight combination for obtaining application preference of the user through which content suitable for the recommendation purpose may be recommended by using various machine learning algorithms on the information on the number of selections for each content provider, the average viewing time, and the viewing time for each content.

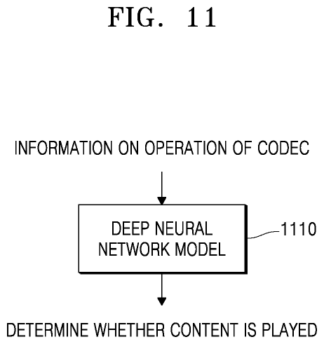

FIG. 11 is a diagram illustrating an example of a method by which an electronic device determines whether content is played by using information on an operation of a codec by using AI according to an embodiment of the present disclosure.

The electronic device 100 according to an embodiment of the present disclosure may determine whether content is executed by using a neural network trained to receive operation information of a codec for the content for each session as an input and output whether the content is executed.

The electronic device 100 according to an embodiment of the present disclosure may determine whether the content is played by using a neural network trained to receive the operation information of the codec for the content for each session as an input and output whether the content is played.

The electronic device 100 according to an embodiment of the present disclosure may determine whether the content is viewed by using a neural network trained to receive the operation information of the codec for the content for each session as an input and output whether the content is viewed.

The same description as that made for the AI with reference to FIG. 10 will be omitted.

In an embodiment using a deep learning algorithm, the processor 110 may predict whether an item selected by a user from among a plurality of recommended items is played, viewed, or executed by using a pre-trained deep neural network model 1110.

The pre-trained deep neural network model 1110 may be an AI model trained through learning in which the operation information of the codec among device log information on content for each session is used as an input value and whether each content is played, viewed, or executed is used as an output value.

The deep neural network model may be, for example, a convolutional neural network (CNN). However, the present disclosure is not limited thereto, and the deep neural network model may be a known AI model including at least one of a recurrent neural network (RNN), a restricted Boltzmann machine (RBM), a deep belief network (DBN), a bidirectional recurrent deep neural network (BRDNN), and a deep Q-network.

The electronic device 100 according to an embodiment of the present disclosure may increase the accuracy of determining whether content is played by using various machine learning algorithms on the operation information of the codec for each content.

FIGS. 12 to 14 are diagrams illustrating examples in which an electronic device calculates a score for each application by applying a weight to a number of times of viewing for each application and a content viewing duration for each content predicted by the electronic device, and determines application preference information based on the calculated score according to an embodiment of the present disclosure.

The electronic device 100 according to the embodiment of FIGS. 12 to 14 may calculate a score for a number of times of content viewing for each application, may calculate a score for a content viewing duration for each application, and may determine a preference of an application according to a sum of the scores. In an embodiment, the electronic device 100 may determine that a preference of a user for an application having a greater sum is higher than a preference for an application having a smaller sum.

The electronic device 100 according to the embodiment of FIGS. 12 to 14 may apply a greater weight to the score calculated for the number of times of content viewing for each application than to the score calculated for the content viewing duration for each application. When preference information is determined by determining that the number of times the user enters content is more important than the content viewing duration, the electronic device 100 may apply a greater weight to the score calculated for the number of times of content viewing for each application than to the score calculated for the content viewing duration for each application.

Referring to FIGS. 12 to 14, the electronic device 100 according to an embodiment may calculate the score for the number of times of content viewing for each application and the score for the content viewing duration for each application based on a ratio value rather than an absolute value so that an error does not occur due to a unit difference between the number of times of content viewing for each application (one time, two times, three times, . . . ) and the content viewing duration for each application (100 minutes, 200 minutes, 300 minutes, . . . ).

FIG. 12 is a diagram illustrating an example in which an electronic device performs scoring by applying a weight for each date to a number of times each content is viewed in a plurality of applications in order to determine application preference information according to an embodiment of the present disclosure.

The electronic device 100 according to an embodiment of FIG. 12 may predict that content C1 was viewed one time today, content C2 was viewed two times one day ago, and content C1 was viewed four times two days ago in a first application by a user. In an embodiment, prediction of content viewing may be performed in the same manner as the method described in operation S620 of FIG. 6.

The electronic device 100 according to an embodiment of FIG. 12 may predict that content C1 was viewed two times today, content C2 was viewed three times three days ago, and content C1 was viewed one time five days ago in a second application by the user. In an embodiment, prediction of content viewing may be performed in the same manner as the method described in operation S620 of FIG. 6.

The electronic device 100 according to an embodiment of the present disclosure may perform scoring by applying a weight for each date to a number of times each content is viewed in a plurality of applications.

The electronic device 100 according to an embodiment of the present disclosure may assign a smaller weight to the number of times of viewing as time passes from a day when the user viewed the content.

For example, when the content was viewed today, the electronic device 100 may add the number of times as it is, but when the content was viewed one day ago, the electronic device 100 may obtain a score for the number of times of viewing by adding a value obtained by multiplying the number of times of viewing by weight 1. When the content was viewed two days ago, the electronic device 100 may obtain a score for the number of times of viewing by adding weight 2 to the number of times of viewing. Weight 1 may be a value greater than weight 2.

In the embodiment of FIG. 12, the electronic device 100 may obtain a score for the number of times content is viewed during a certain period in each application by an equation such as {(Today count*1.00)+(Today−1 count*weight1)+(Today−2count*weight2)+ . . . }.

A score for the number of times content is viewed in the first application may be calculated as 5.9999 by the above equation (1*1+2*weight1+4*weight2=5.9999).

A score for the number of times content is viewed in the second application may be calculated as 5.8618870499(1*2+3*weight3+1*weight4=5.861887099). Weight 1 may be greater than weight 2, weight 2 may be greater than weight 3, and weight 3 may be greater than weight 4.

The electronic device 100 according to an embodiment of the present disclosure may convert the score for the number of times content is viewed in each application into a ratio value by an equation of {App1 Session Count Score Ratio=App1 Session Count Score/(App1 Session count score+App2 Session count score)}.

In the embodiment of FIG. 12, the electronic device 100 may convert the score for the number of times content is viewed in the first application into 0.5058, which is a ratio value, by the above equation (5.9999/(5.9999+5.8618870499)=0.5058).

In the embodiment of FIG. 12, the electronic device 100 may convert the score for the number of times content is viewed in the second application into 0.4942, which is a ratio value, by the above equation (5.8618870499/(5.9999+5.8618870499)=0.4942).

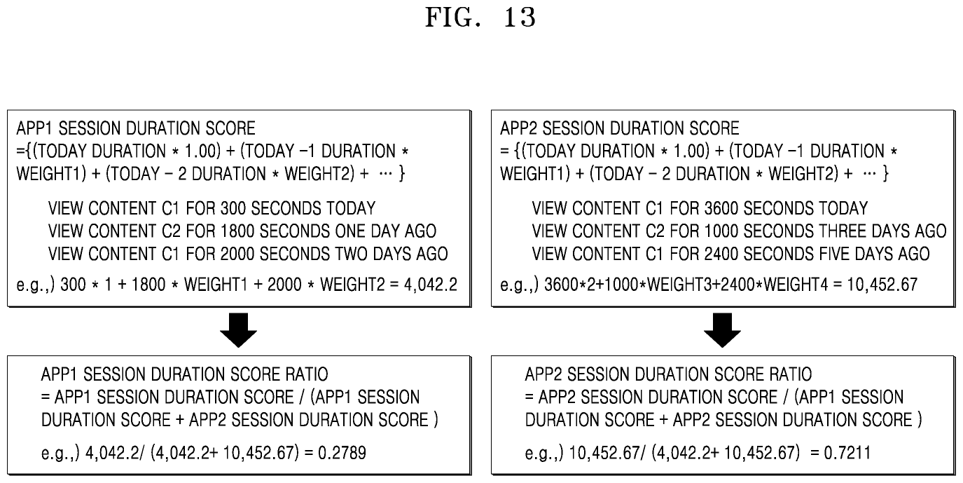

FIG. 13 is a diagram illustrating an example in which an electronic device performs scoring by applying a weight for each date to a time during which each content is viewed in a plurality of applications in order to determine application preference information according to an embodiment of the present disclosure.

The electronic device 100 according to an embodiment of FIG. 13 may predict that content C1 was viewed for 300 seconds today, content C2 was viewed for 1800 seconds one day ago, and content C1 was viewed for 2000 seconds two days ago in a first application by a user. In an embodiment, prediction of content viewing may be performed in the same manner as the method described in operation S620 of FIG. 6.

The electronic device 100 according to an embodiment of FIG. 13 may predict that content C1 was viewed for 3600 seconds today, content C2 was viewed for 1000 seconds three days ago, and content C1 was viewed for 2400 seconds five days ago in a second application by the user. In an embodiment, prediction of content viewing may be performed in the same manner as the method described in operation S620 of FIG. 6.

The electronic device 100 according to an embodiment of the present disclosure may perform scoring by applying a weight for each date to a number of times each content is viewed in a plurality of applications.

The electronic device 100 according to an embodiment of the present disclosure may assign a smaller weight to the viewing time as time passes from a day when the user viewed the content.

For example, when the content was viewed today, the electronic device 100 may apply the viewing time as it is, but when the content was viewed one day ago, the electronic device 100 may obtain a score for the viewing time by adding a value obtained by multiplying the viewing time by weight 1. Similarly, when the content was viewed two days ago, the electronic device 100 may obtain a score for the viewing time by adding weight 2 to the viewing time

In the embodiment of FIG. 13, the electronic device 100 may obtain a score for the time during content is viewed in each application by an equation such as {(Today duration*1.00)+(Today−1 duration*weight1)+(Today−2 duration*weight2)+ . . . }.

A score for the time during content is viewed in the first application may be calculated as 4042.2 by the above equation (300*1+1800*weight1+2000*weight2=4,042.2).

A score for the number of times content is viewed in the second application may be calculated as 10,452.667 by the above equation (3600*2+1000*weight3+2400*weight4=10,452.67).

The electronic device 100 according to an embodiment of the present disclosure may convert the score for the time during which content is viewed in each application into a ratio value by an equation of {App1 Session duration Score Ratio=App1 Session Duration Score/(App1 Session Duration Score+App2 Session Duration Score)}.

In the embodiment of FIG. 13, the electronic device 100 may convert the score for the time during content is viewed in the first application into 0.2789, which is a ratio value, by the above equation (4,042.2/(4,042.2+10,452.67)=0.2789).

In the embodiment of FIG. 13, the electronic device 100 may convert the score for the time during which content is viewed in the second application into 0.7211, which is a ratio value, by the above equation (10,452.67/(4,042.2+10,452.67)=0.7211).

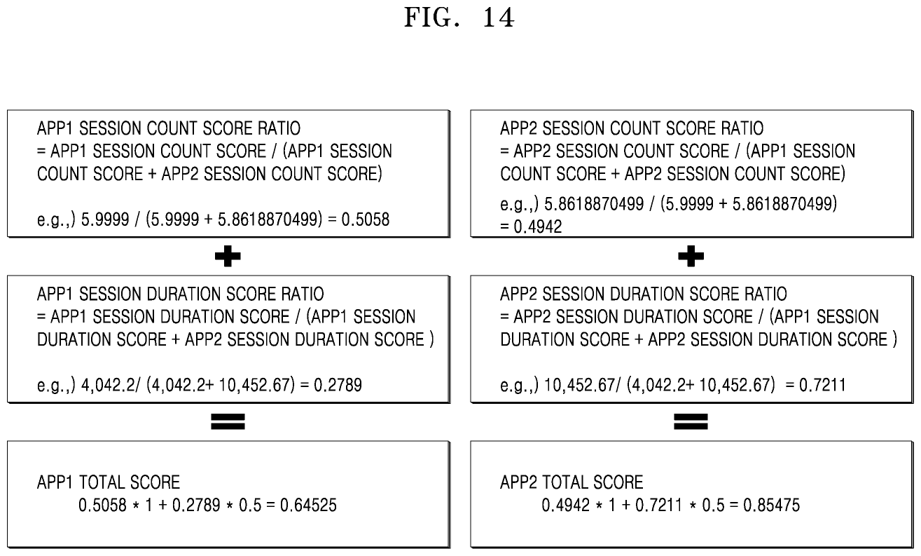

FIG. 14 is a diagram illustrating an example in which an electronic device performs scoring by applying a weight for each item to a score based on a number of times each content is viewed and a viewing time of each content in order to determine application preference information according to an embodiment of the present disclosure.

The electronic device 100 according to an embodiment of the present disclosure may determine a preference for each application of a user according to a value obtained by summing a score for a number of times content is viewed in each application and a score for a time during which the content is viewed in each application.

The electronic device 100 according to an embodiment of the present disclosure may determine the preference for each application of the user according to a value obtained by applying a weight to at least one of the score for the number of times that the content is viewed in each application and the score for the time during which the content is viewed in each application and then summing them.

The electronic device 100 according to the embodiment of FIG. 14 may determine the preference for each application of the user according to a value obtained by applying a weight of 1 to the score for the number of times the content is viewed in each application and applying a weight of 0.5 to the score for the time during which the content is viewed in each application and then summing them.

The electronic device 100 according to the embodiment of FIG. 14 may obtain 0.64525 as a value obtained by applying weights of 1 and 0.5 respectively to a score for a number of times content is viewed in a first application and a time during which the content is viewed in the first application and then summing them (0.5058*1+0.2789*0.5=0.64525).

The electronic device 100 according to the embodiment of FIG. 14 may obtain 0.85475 as a value obtained by applying weights of 1 and 0.5 respectively to a score for a number of times content is viewed in a second application and a time during which the content is viewed in the second application and then summing them (0.4942*1+0.7211*0.5=0.85475).

The electronic device 100 according to the embodiment of FIG. 14 may determine that the preference of the user for the second application having a greater summed value is higher than the preference for the first application.

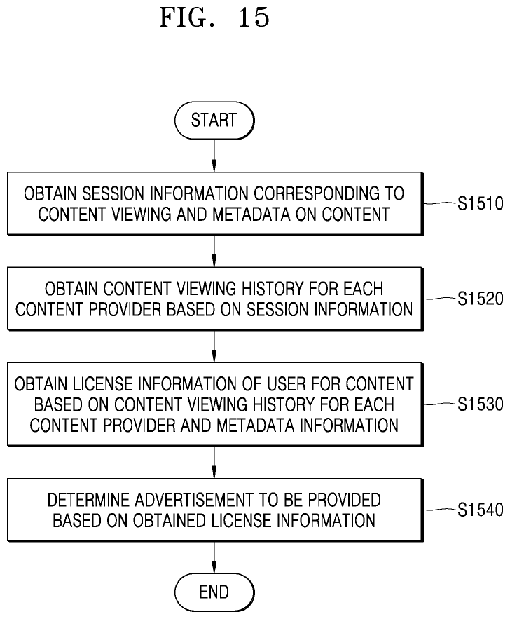

FIG. 15 is a flowchart illustrating an operating method of an electronic device according to an embodiment of the present disclosure.

Referring to FIG. 15, the electronic device 100 according to an embodiment of the present disclosure may obtain session information corresponding to content viewing and metadata information on content (S1510).

In an embodiment, a session may refer to one interval including a viewing history from a time when an application is executed by selecting recommended content to a time when the application is terminated.

Session information may refer to information related to content execution among log information from a time point when a user input for selecting content is obtained to a time point when viewing of the selected content is terminated.

The electronic device 100 according to an embodiment of the present disclosure may obtain session information for each content viewing of a user and metadata information on each content from an external storage device

The electronic device 100 according to an embodiment of the present disclosure may obtain session information for each content viewing of a user and metadata information on each content from a storage device inside the device.

The electronic device 100 according to an embodiment of the present disclosure may obtain session information for each content viewing of a user and metadata information on each content from an external device.

The electronic device 100 according to an embodiment of the present disclosure may obtain a content viewing history for each content provider based on the session information (S1520).

When there exist user input information for selecting one content from among a plurality of pieces of recommended content, execution request information for an application of a content provider providing the selected content, and information indicating that the application is started or executed within a certain time after the execution request for the application, and a codec for executing the selected content is operated for a certain time or longer, the electronic device 100 according to an embodiment of the present disclosure may predict that the selected content provided by the content provider has been viewed. In this case, the electronic device 100 according to an embodiment of the present disclosure may obtain or store information such as a date and time when the user played the content, a content playback time, and the like.

The electronic device 100 according to an embodiment of the present disclosure may predict or infer a time during which the codec for executing the selected content is operated as a time during which the content is viewed or played.

The electronic device 100 according to an embodiment of the present disclosure may obtain license information of the user for each content based on the content viewing history for each content provider and the metadata information (S1530).

When it is predicted that content whose license type is “subscription” among the metadata information of the content has been viewed or played, the electronic device 100 according to an embodiment of the present disclosure may predict that the user is subscribing to the content. This is because content whose license type is “subscription” may be viewed only by a user who is subscribing to the content.

When it is predicted that content whose license type is “purchase” among the metadata information of the content has been viewed or played, the electronic device 100 according to an embodiment of the present disclosure may predict that the user has purchased the content. This is because content whose license type is “purchase” may be viewed only by a user who purchased the content.

When it is predicted that content whose license type is “rental” among the metadata information of the content has been viewed or played, the electronic device 100 according to an embodiment of the present disclosure may predict that the user has rented the content. This is because content whose license type is “rental” may be viewed only by a user who rented the content.

When it is predicted that content whose license type is “free” among the metadata information of the content has been viewed or played, the electronic device 100 according to an embodiment of the present disclosure may predict that the user has viewed the content for free without purchasing, renting, or subscribing to the content. This is because content whose license type is “free” may be viewed by all users.

According to an embodiment of the present disclosure, when the metadata information of the content includes two or more types such as content having a license type of “purchase” or “rental”, content having a license type of “purchase” or “subscription”, and content having a license type of “purchase”, “rental”, or “subscription”, the electronic device 100 may predict the license information of the user for the corresponding content by referring to at least one of a metadata information change history of the corresponding content, a viewing history of other pieces of content in the same application, and license information of the user predicted for other pieces of content in the same application.

The electronic device 100 according to an embodiment of the present disclosure may determine an advertisement to be provided together with the content based on the obtained license information of the user (S1540).

The electronic device 100 according to an embodiment of the present disclosure may determine an advertisement to be provided together with the content based on the predicted content viewing history of the user for each content provider and the predicted license information of the user for each content.

The electronic device 100 according to an embodiment of the present disclosure may provide, together with content predicted as not being subscribed to by the user, an advertisement for subscription of an application providing the content.

The electronic device 100 according to an embodiment of the present disclosure may provide, together with content predicted as being subscribed to by the user, an advertisement for a product related to a genre, an actor, or a story of the content.

The electronic device 100 according to an embodiment of the present disclosure may obtain a content viewing pattern for each time slot of the user based on the predicted content viewing history for each content provider of the user.

The electronic device 100 according to an embodiment of the present disclosure may use the content viewing pattern for each time slot of the user for content recommendation.

The electronic device 100 according to an embodiment of the present disclosure may determine a time slot in which the user mainly views each application, and may use the determined time slot for content recommendation.

The electronic device 100 according to an embodiment of the present disclosure may determine a time slot in which the user mainly views each application and may determine whether to automatically execute a mainly used application in the corresponding time slot.

The operating method of the electronic device described with reference to FIGS. 1 to 15 may be shared not only by one electronic device 100 but also by one or more other electronic devices that are used with the same user account or are determined to be used by the same user through user identification.

That is, one or more other electronic devices that are used by the same user account or determined to be used by the same user through user identification may share data stored in a database and recommend content according to a synchronized criterion.

Furthermore, session information for content viewed by any one of one or more electronic devices that are used with the same user account or determined to be used by the same user through user identification may be shared by all devices.

The operating method of the electronic device 100 according to an embodiment may also be implemented in the form of a computer-readable medium including instructions executable by a computer, such as a program module executed by a computer. The computer-readable medium may be any available medium that may be accessed by a computer and includes both volatile and nonvolatile media, and removable and non-removable media. The computer-readable medium may include program instructions, data files, data structures, and the like alone or in combination. The program instructions recorded on the medium may be specially designed and configured for the present disclosure or may be known and available to those skilled in the art of computer software. Examples of the computer-readable recording medium include magnetic media such as a hard disk, a floppy disk, and a magnetic tape, optical media such as a CD-ROM and a DVD, magneto-optical media such as a floptical disk, and hardware devices specially configured to store and execute program instructions, such as a ROM, a RAM, and a flash memory. Examples of the program instructions may include not only machine language code such as that generated by a compiler, but also high-level language code that may be executed by a computer using an interpreter or the like.

According to an embodiment, a method according to various embodiments disclosed herein may be included and provided in a computer program product. The computer program product may be traded between a seller and a buyer as a product. The computer program product may be distributed in the form of a machine-readable storage medium (e.g., a compact disc read-only memory (CD-ROM)), or may be distributed (e.g., downloaded or uploaded) online through an application store or directly between two user devices (e.g., smartphones). In the case of online distribution, at least a portion of the computer program product (e.g., a downloadable app) may be at least temporarily stored or temporarily generated in a machine-readable storage medium such as a memory of a manufacturer's server, a server of an application store, or a relay server.

The above description is for illustrative purposes, and those of ordinary skill in the art to which the present disclosure pertains will understand that modifications may be made in other specific forms without changing the technical spirit or essential features of the present disclosure. Therefore, it should be understood that the embodiments described above are exemplary and not restrictive in all aspects. For example, each component described as a single type may implemented in a distributed manner, and similarly, components described as being distributed may also be implemented in a combined form.

An operating method of an electronic device according to an embodiment may include obtaining license information of a user for content according to a content viewing history for each content provider obtained based on session information corresponding to content viewing and metadata information on the content, obtaining application subscription information and application preference information of the user according to the content viewing history for each content provider and the license information, and obtaining recommended content according to the application subscription information and the application preference information of the user.

The session information may include at least one of user input information corresponding to selection of one content from among a plurality of pieces of recommended content, execution request information for an application of a content provider providing the selected content, information on start and termination of the application, and information on an operation of a codec for executing the selected content.

The session information may include at least one of power on/off information of the electronic device and operation information of a screen saver.

The session information may be information related to content execution among log information from a time point when a user input corresponding to selection of the content is obtained to a time point when viewing of the selected content is terminated.

The obtaining of the content viewing history for each content provider may include identifying viewing of the selected content provided by the content provider, when user input information corresponding to selection of one content from among a plurality of pieces of recommended content exists, execution request information for an application of a content provider providing the selected content exists, the application is executed within a preset time after the execution request for the application, and a codec for the selected content is operated for a preset time or longer.

The obtaining of the license information of the user may include obtaining the license information of the user for the content as one of free, subscription, rental, and purchase according to the content viewing history for each content provider obtained based on the session information and the metadata information, and the obtaining of the recommended content may include, when a plurality of content providers provide the same content, identifying a priority corresponding to the plurality of content providers based on the application subscription information and the application preference information.

The identifying of the priority may include identifying content of a content provider to which the user is subscribing as a highest priority according to the application subscription information, and when the application subscription information is the same, identifying a priority according to the application preference information based on a number of selections for each content provider, an average viewing time, and a viewing time for the content. The application preference information may be identified according to a score calculated by applying a weight to at least one of the number of selections for each content provider, the average viewing time, and the viewing time for the content.

The weight may be obtained by using a neural network trained to receive, as inputs, information on the number of selections for each content provider, the average viewing time, and the viewing time for the content, and a recommendation purpose and output the weight.

An electronic device according to an embodiment may include memory storing one or more instructions, and one or more processors configured to execute the one or more instructions stored in the memory to obtain license information of a user for content according to a content viewing history for each content provider obtained based on session information corresponding to content viewing and metadata information on the content, obtain application subscription information and application preference information of the user according to the content viewing history for each content provider and the license information, and obtain recommended content according to the application subscription information and the application preference information of the user.

The session information may include at least one of user input information corresponding to selection of one content from among a plurality of pieces of recommended content, execution request information for an application of a content provider providing the selected content, information on start and termination of the application, and information on an operation of a codec for executing the selected content.

The session information may include at least one of power on/off information of the electronic device and operation information of a screen saver.

The session information may be information related to content execution among log information from a time point when a user input corresponding to selection of the content is obtained to a time point when viewing of the selected content is terminated.

The one or more processors may be further configured to execute the one or more instructions to identify viewing of the selected content provided by the content provider, when user input information corresponding to selection of one content from among a plurality of pieces of recommended content exists, execution request information for an application of a content provider providing the selected content exists, the application is executed within a certain time after the execution request for the application, and a codec for the selected content is operated for a certain time or longer.

The one or more processors may be further configured to execute the one or more instructions to obtain the license information of the user for the content as one of free, subscription, rental, and purchase according to the content viewing history for each content provider obtained based on the session information and the metadata information.

The one or more processors may be further configured to execute the one or more instructions to, when a plurality of content providers provide the same content, identify priorities corresponding to the plurality of content providers based on the application subscription information and the application preference information.

The one or more processors may be further configured to execute the one or more instructions to identify content of a content provider to which the user is subscribing as a highest priority according to the application subscription information, and when the application subscription information is the same, identify a priority according to the application preference information based on a number of selections for each content provider, an average viewing time, and a viewing time for the content.

The application preference information may be identified according to a score calculated by applying a weight to at least one of the number of selections for each content provider, the average viewing time, and the viewing time for the content.

There may be provided a computer-readable recording medium having recorded thereon a program for performing, on a computer, the operating method of the electronic device.

1. An operating method of an electronic device, comprising:
obtaining license information of a user for content according to a content viewing history associated with a content provider that is obtained based on session information corresponding to content viewing and metadata information for the content;
obtaining application subscription information and application preference information of the user by making an inference from the content viewing history associated with the content provider and the license information; and
obtaining recommended content based on the application subscription information and the application preference information of the user.

2. The operating method of the electronic device of claim 1, wherein the session information comprises:
at least one of user input information corresponding to a selection of one content from among a plurality of pieces of the recommended content, execution request information for an application of a respective content provider providing the one content corresponding to the selection, information on start and termination of the application, and information on an operation of a codec for executing the one content corresponding to the selection.

3. The operating method of the electronic device of claim 1, wherein the session information comprises at least one of power on/off information and operation information of a screen saver.

4. The operating method of the electronic device of claim 1, wherein the session information is information related to content execution among log information from a time point of a user input corresponding to selection of the content being obtained to a time point of viewing of the content is terminated.

5. The operating method of the electronic device of claim 2, wherein the obtaining of the content viewing history associated with the content provider comprises:
identifying viewing of the content corresponding to the selection provided by the content provider, based on user input information corresponding to the selection of one content from among a plurality of pieces of the recommended content existing, execution request information for an application of a content provider providing the content corresponding to the selection exists, the application is executed within a preset time after the execution request for the application, and a codec for the content corresponding to the selection is operated for a preset time or longer.

6. The operating method of the electronic device of claim 1, wherein the obtaining of the license information of the user comprises obtaining the license information of the user for the content as one of free, subscription, rental, and purchase according to the content viewing history associated with the content provider obtained based on the session information and the metadata information.

7. The operating method of the electronic device of claim 1, wherein the content provider being among a plurality of content providers and the obtaining of the recommended content comprises:
based on the plurality of content providers providing same content, identifying a priority corresponding to the plurality of content providers based on the application subscription information and the application preference information.

8. The operating method of the electronic device of claim 7, wherein the identifying of the priority comprises:
identifying content of a content provider to which the user is subscribing as a highest priority according to the application subscription information; and
based on the application subscription information is same, identifying a priority according to the application preference information based on a number of selections associated with the content provider, an average viewing time, and a viewing time for the content.

9. The operating method of the electronic device of claim 8, wherein the application preference information is identified according to a score calculated by applying a weight to at least one of the number of selections associated with the content provider, the average viewing time, and the viewing time for the content.

10. The operating method of the electronic device of claim 9, wherein the weight is obtained by using a neural network trained to receive, as inputs, information on the number of selections associated with the content provider, the average viewing time, and the viewing time for the content, and a recommendation purpose, and output the weight.

11. An electronic device comprising:
a memory to store one or more instructions; and
one or more processors configured to execute the one or more instructions stored in the memory to
obtain license information of a user for content according to a content viewing history associated with a content provider obtained based on session information corresponding to content viewing and metadata information for the content,
obtain application subscription information and application preference information of the user by making an inference from the content viewing history associated with the content provider and the license information, and
obtain recommended content according to the application subscription information and the application preference information of the user.

12. The electronic device of claim 11, wherein the session information comprises at least one of user input information corresponding to selection of one content from among a plurality of pieces of recommended content, execution request information for an application of a content provider providing the content, information on start and termination of the application, and information on an operation of a codec for executing the content.

13. The electronic device of claim 11, wherein the session information comprises at least one of power on/off information and operation information of a screen saver.

14. The electronic device of claim 11, wherein the session information is information related to content execution among log information from a time point based on a user input corresponding to selection of the content is obtained to a time point based on viewing of the selected content is terminated.

15. A non-transitory computer-readable recording medium having recorded thereon a program executable by a computer to perform the operating method of claim 1.
